(19) United States
(12) Patent Application Publication
(10) Pub. No.: US 2026/0254556 A1
(43) Pub. Date: Aug. 27, 2026

(54) PHYSICAL LAYER PROCESSING IN SIDELINK TRANSMISSION

(71) Applicant: QUALCOMM Incorporated, San Diego, CA (US)

(72) Inventors: Daniel HOROVITZ, Kiryat Tivon (IL); Moshe BEN-ARI, Rehovot (IL); Alexander SVERDLOV, Rehovot (IL); Michael LEVITSKY, Rehovot (IL)

(21) Appl. No.: 19/059,717

(22) Filed: Feb. 21, 2025

(51) Int. Cl. H04L 1/00; H04L 5/00; H04W 72/25

(52) U.S. Cl. CPC H04L 1/0004; H04L 1/001; H04L 5/0053; H04W 72/25

(57) ABSTRACT

Certain aspects of the present disclosure provide techniques for wireless communications. An example method includes generating a sidelink control information (SCI) payload; and transmitting the SCI payload on a first antenna and a second antenna, wherein at least one of: a first configuration of bits of the SCI payload is associated with the first antenna and a second configuration of the bits of the SCI payload is associated with the second antenna, or a first configuration of modulation symbols of the SCI payload is associated with the first antenna and a second configuration of modulation symbols of the SCI payload is associated with the second antenna, or resource blocks of the SCI payload are alternated between the first antenna and the second antenna.

### INTRODUCTION

### Field of the Disclosure

Aspects of the present disclosure relate to wireless communications, and more particularly, to techniques for physical layer processing in sidelink transmission.

### Description of Related Art

Wireless communications systems are widely deployed to provide various telecommunication services such as telephony, video, data, messaging, broadcasts, or other similar types of services. These wireless communications systems may employ multiple-access technologies capable of supporting communications with multiple users by sharing available wireless communications system resources with those users.

Although wireless communications systems have made great technological advancements over many years, challenges still exist. For example, complex and dynamic environments can still attenuate or block signals between wireless transmitters and wireless receivers. Accordingly, there is a continuous desire to improve the technical performance of wireless communications systems, including, for example: improving speed and data carrying capacity of communications, improving efficiency of the use of shared communications mediums, reducing power used by transmitters and receivers while performing communications, improving reliability of wireless communications, avoiding redundant transmissions and/or receptions and related processing, improving the coverage area of wireless communications, increasing the number and types of devices that can access wireless communications systems, increasing the ability for different types of devices to intercommunicate, increasing the number and type of wireless communications mediums available for use, and the like. Consequently, there exists a need for further improvements in wireless communications systems to overcome the aforementioned technical challenges and others.

### SUMMARY

Certain aspects provide a method for wireless communications by a user equipment (UE). The method includes generating a sidelink control information (SCI) payload; and transmitting the SCI payload on a first antenna and a second antenna, wherein at least one of: a first configuration of bits of the SCI payload is associated with the first antenna and a second configuration of the bits of the SCI payload is associated with the second antenna, or a first configuration of modulation symbols of the SCI payload is associated with the first antenna and a second configuration of modulation symbols of the SCI payload is associated with the second antenna, or resource blocks of the SCI payload are alternated between the first antenna and the second antenna.

Other aspects provide: one or more apparatuses operable, configured, or otherwise adapted to perform any portion of any method described herein (e.g., such that performance may be by only one apparatus or in a distributed fashion across multiple apparatuses); one or more non-transitory, computer-readable media comprising instructions that, when executed by one or more processors of one or more apparatuses, cause the one or more apparatuses to perform any portion of any method described herein (e.g., such that instructions may be included in only one computer-readable medium or in a distributed fashion across multiple computer-readable media, such that instructions may be executed by only one processor or by multiple processors in a distributed fashion, such that each apparatus of the one or more apparatuses may include one processor or multiple processors, and/or such that performance may be by only one apparatus or in a distributed fashion across multiple apparatuses); one or more computer program products embodied on one or more computer-readable storage media comprising code for performing any portion of any method described herein (e.g., such that code may be stored in only one computer-readable medium or across computer-readable media in a distributed fashion); and/or one or more apparatuses comprising one or more means for performing any portion of any method described herein (e.g., such that performance would be by only one apparatus or by multiple apparatuses in a distributed fashion). By way of example, an apparatus may comprise a processing system, a device with a processing system, or processing systems cooperating over one or more networks. An apparatus may comprise one or more memories; and one or more processors configured to cause the apparatus to perform any portion of any method described herein. In some examples, one or more of the processors may be preconfigured to perform various functions or operations described herein without requiring configuration by software.

The following description and the appended figures set forth certain features for purposes of illustration.

### BRIEF DESCRIPTION OF DRAWINGS

The appended figures depict certain features of the various aspects described herein and are not to be considered limiting of the scope of this disclosure.

FIG. 1 depicts an example wireless communications network.

FIG. 2 depicts an example disaggregated base station architecture.

FIG. 3 depicts aspects of network entities and a user equipment (UE).

FIGS. 4A, 4B, 4C, and 4D depict various example aspects of data structures for a wireless communications network.

FIG. 5 depicts an example of sidelink communications.

FIG. 6 depicts an example of sidelink communications and access link communications.

FIG. 7 depicts an example transmitter chain and an example receiver chain for orthogonal frequency division multiplexing communications.

FIG. 8 depicts an example channel model for 2×2 multiple-input multiple-output (MIMO) communications between UEs for sidelink communications.

FIG. 9 depicts an example architecture of certain physical layer processing at a transmitter for sidelink communications.

FIG. 10 depicts an example architecture of certain physical layer processing of bits at a receiver for sidelink communications.

FIG. 11 depicts an example architecture of certain physical layer processing of modulation symbols at a receiver for sidelink communications.

FIG. 12 depicts an example resource block transmission scheme across a bandwidth in the frequency domain.

FIG. 13 depicts a method for wireless communications.

FIG. 14 depicts aspects of an example communications device.

### DETAILED DESCRIPTION

Aspects of the present disclosure provide apparatuses, methods, processing systems, and computer-readable mediums for physical layer processing in sidelink transmission.

Wireless communication networks, e.g., New Radio (NR) networks, may provide a standardized topology, known as sidelink transmission, that supports direct communications between two or more user equipment (UE) devices even when cellular network coverage is absent. Sidelink transmission can expand cellular system coverage and is being designed to deliver a broad set of benefits for the overall 5G system. It can operate in different spectrum configurations such as dedicated, in-band licensed, and unlicensed, providing the flexibility for adoption in diverse settings, which may allow support for a wide range of devices in a variety of use cases.

At the physical layer, a combination of technologies that complement one another are typically used: Multiple-Input Multiple-Output (MIMO) and Orthogonal Frequency-Division Multiplexing (OFDM). MIMO is a technology frequently used to improve the speed and quality of wireless data transfers. MIMO works by sending and receiving different data using multiple antenna ports, thus increasing the number of antenna ports in the data transfer path. Examples of MIMO systems include 2×2 MIMO, which uses two transmitting (Tx) and two receiving (Rx) antennas, or 4×4 MIMO, where four Tx antennas and four Rx antennas are used. MIMO is typically supported for uplink and downlink connections between user equipment (UE) and network entities such as base stations, as well as sidelink transmission between individual UE.

In MIMO, multiple streams of data, known as “MIMO layers,” are created and mapped to individual antenna ports. For example, a first MIMO layer may be mapped to a first antenna port, a second MIMO layer may be mapped to a second antenna port, and so on. Thus, the maximum number of MIMO layers is equal to the number of available antenna ports. Then, parallel processing is performed on the MIMO layers, where the same parallel processing is used at both the transmitter and receiver so that the signals received at each antenna port of the receiver can be separated from one another. Each of the parallel-processed data streams is sent from the corresponding antenna port, and a respective receive antenna port receives the mixed signals from each of the transmit antennas. The receiver performs reverse parallel processing to the parallel processing used at the transmitter to separate the mixed signals and recreate the MIMO layers.

In conventional MIMO technology, frequency, phase, and timing are synchronized when the signals are sent. However, due to channel conditions, e.g., the distance between antennas in the wireless area and the presence of interfering objects such as buildings, the signals may be attenuated and delayed, causing frequency and amplitude/phase errors at the receiver antennas. The receiver corrects these errors using techniques such as equalization to recover the original data.

In some examples of sidelink transmission, the sidelink control information payload is divided into two stages to achieve maximum control information flexibility. The first stage (SCI-1) is transmitted using the physical sidelink control channel (PSCCH) and the second stage (SCI-2) is transmitted using the physical sidelink shared channel (PSSCH).

While the PSSCH can be transmitted using one or more MIMO layers, SCI-2 has been defined to be transmitted on only a single MIMO layer due to more robust requirements for control information over data. As a result, in cases where a PSSCH uses multiple layers in MIMO, SCI-2 is duplicated and identical information is mapped to all MIMO layers. Thus, identical signals are transmitted on the respective antenna ports.

This duplication allows for common channel estimation between the PSSCH and SCI-2, which increases processing efficiency. However, a technical problem is also introduced in that the transmission of identical signals on both antenna ports may create nulls in the radiation pattern in some directions. A null is an area or direction that is associated with lower than a threshold level of signal strength. This may complicate the decoding of the SCI-2 information in all directions because all UEs in all directions are expected to decode all control data and a UE may be located in a null when receiving SCI-2 information, leading to failure to decode the control data. One possibility is making adjustments to precoding in the MIMO transmission, but such adjustments may remedy nulling in some direction while other directions could still be nulled.

Aspects described herein may overcome this technical problem by modifying the physical layer processing and transmission of the SCI-2 information in a multi-layer PSSCH such that the signals on each antenna port are not identical, even though the data carried over SCI-2 is still the same for both antennas and is still robust from a demodulation perspective, as compared to actual two-layer demodulation. For example, some aspects provide techniques to use different configurations, e.g., by applying different interleaving patterns or scrambling sequences, of the individual bit stream at each antenna port. Some aspects provide techniques to use different configurations, e.g., by applying a pseudo-random phase rotation or interleaving pattern, in the individual modulation symbols at each antenna port. Some aspects provide techniques to alternate the transmission of the resource blocks of the control payload comprising the SCI-2 information in the frequency domain between the two antenna ports to prevent the transmissions on each antenna port from being identical.

Such techniques may prevent the technical problem of nulls from forming, and thus keep the SCI-2 information robust while still allowing for the efficiencies of common channel estimation between the PSSCH and SCI-2 information.

### Introduction to Wireless Communications Networks

The techniques and methods described herein may be used for various wireless communications networks. While aspects may be described herein using terminology commonly associated with 3G, 4G, 5G, 6G, and/or other generations of wireless technologies, aspects of the present disclosure may likewise be applicable to other communications systems and standards not explicitly mentioned herein.

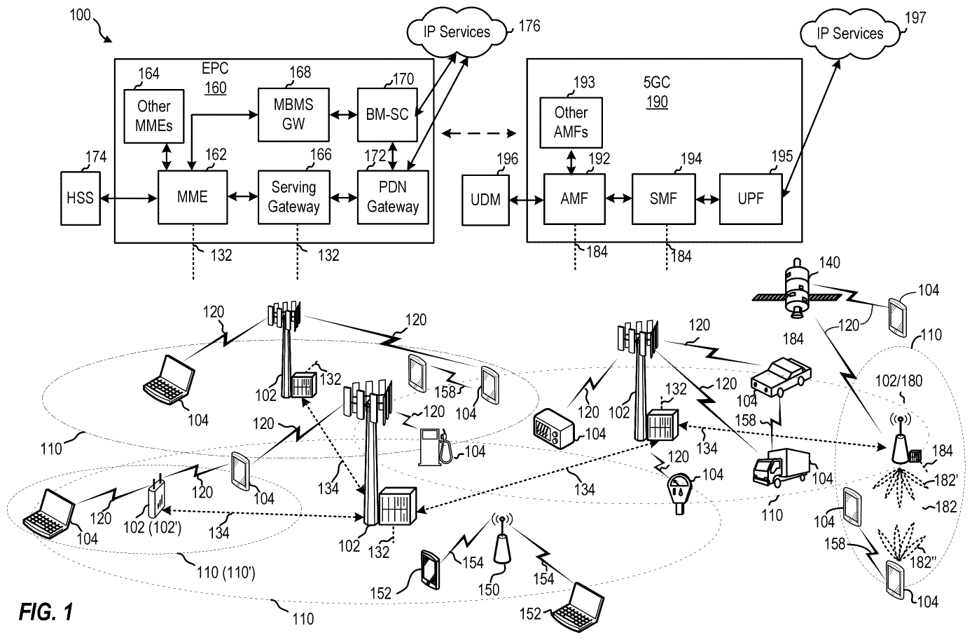

FIG. 1 depicts an example of a wireless communications network 100, in which aspects described herein may be implemented.

Generally, wireless communications network 100 includes various network entities (alternatively, network elements or network nodes). A network entity is generally a communications device and/or a communications function performed by a communications device (e.g., a user equipment (UE), a base station (BS), a component of a BS, a server, etc.). As such communications devices are part of wireless communications network 100, and facilitate wireless communications, such communications devices may be referred to as wireless communications devices. For example, various functions of a network as well as various devices associated with and interacting with a network may be considered network entities. Further, wireless communications network 100 may include terrestrial aspects, such as ground-based network entities (e.g., BSs 102), and non-terrestrial aspects (also referred to herein as non-terrestrial network entities). A non-terrestrial network entity may include satellite 140, which may be an example of an aerial or space-borne platform. In some examples, satellite 140 may include one or more network entities on-board (e.g., one or more BSs) capable of communicating with other network elements (e.g., terrestrial BSs) and UEs. For example, satellite 140 may be implemented according to a regenerative architecture (also referred to as a non-transparent architecture), and a gNB implemented at satellite 140 may implement higher-layer network functions. As another example, satellite 140 may be implemented according to a transparent architecture, and may perform a physical or other lower-layer repeater function for UEs and a network entity (such as a gateway associated with the satellite 140).

In the depicted example, wireless communications network 100 includes BSs 102, UEs 104, and one or more core networks, such as an Evolved Packet Core (EPC) 160 or a 5G Core (5GC) network 190, which interoperate to provide communications services over various communications links, including wired and wireless links. In some aspects, a core network, such as a 6G core, may implement a converged service-based architecture. In a converged service-based architecture, functions traditionally split between a core network (such as 5GC network 190) and a radio access network (RAN) (such as BS 102) may be implemented at a single network entity. For example, a mobility network entity may perform both core network functions and RAN functions related to mobility of UEs 104 attached to the wireless communications network 100. “Network entity” can refer to a BS 102, a network entity of EPC 160 or 5GC network 190, or a network entity of a converged service-based architecture.

FIG. 1 depicts various example UEs 104. UE 104 may include a cellular phone, a smart phone, a session initiation protocol (SIP) phone, a laptop, a personal digital assistant (PDA), a satellite radio, a Global Positioning System device, a multimedia device, a video device, a digital audio player, a camera, a game console, a tablet, a smart device, a wearable device, a vehicle, an electric meter, a gas pump, a kitchen appliance, a healthcare device, an implant, a sensor/actuator, a display, an Internet of Things (IoT) device, an always on (AON) device, an edge processing device, a data center, or another similar device. A UE 104 may also be referred to as a mobile device, a wireless device, a station, a mobile station, a subscriber station, a mobile subscriber station, a mobile unit, a subscriber unit, a wireless unit, a remote unit, a remote device, an access terminal, a mobile terminal, a wireless terminal, a remote terminal, a handset, and others.

BSs 102 wirelessly communicate with (e.g., transmit signals to or receive signals from) UEs 104 via communications links 120. A communications link 120 between a BS 102 and a UE 104 may include uplink (UL) (also referred to as reverse link) transmissions from a UE 104 to a BS 102 and/or downlink (DL) (also referred to as forward link) transmissions from a BS 102 to a UE 104. A communications link 120 may use multiple-input and multiple-output (MIMO) antenna technology, including spatial multiplexing, beamforming, and/or transmit diversity in various aspects.

A BS 102 may include a NodeB, an enhanced NodeB (eNB), a next generation enhanced NodeB (ng-eNB), a next generation NodeB (gNB or gNodeB), an access point, a base transceiver station, a radio base station, a radio transceiver, a transceiver function, a transmission reception point (TRP), a radio unit (RU), a distributed unit (DU), or the like. A given BS 102 may provide communications coverage for a coverage area 110, which may sometimes be referred to as a cell, and which may overlap another coverage area 110 (e.g., a small cell provided by a BS 102′) may have a coverage area 110′ that overlaps the coverage area 110 of a macro cell). A BS 102 may, for example, provide communications coverage for a macro cell (covering a relatively large geographic area), a pico cell (covering a relatively smaller geographic area, such as a sports stadium), a femto cell (covering a relatively smaller geographic area, such as a home), or another type of cell.

The term “cell” may refer to a portion, partition, or segment of wireless communication coverage served by a network entity within a wireless communications network 100. A cell may have geographic characteristics, such as a geographic coverage area, as well as radio frequency characteristics, such as time and/or frequency resources dedicated to the cell. For example, a specific geographic coverage area may be covered by multiple cells employing different frequency resources (e.g., bandwidth parts) and/or different time resources. As another example, a specific geographic coverage area may be covered by a single cell. In some contexts (e.g., a carrier aggregation scenario and/or multi-connectivity scenario), the terms “cell” or “serving cell” may refer to or correspond to a specific carrier frequency (e.g., a component carrier) used for wireless communications, and a “cell group” may refer to or correspond to multiple carriers used for wireless communications. As examples, in a carrier aggregation scenario, a UE may communicate on multiple component carriers corresponding to multiple (serving) cells in the same cell group, and in a multi-connectivity (e.g., dual connectivity) scenario, a UE may communicate on multiple component carriers corresponding to multiple cell groups.

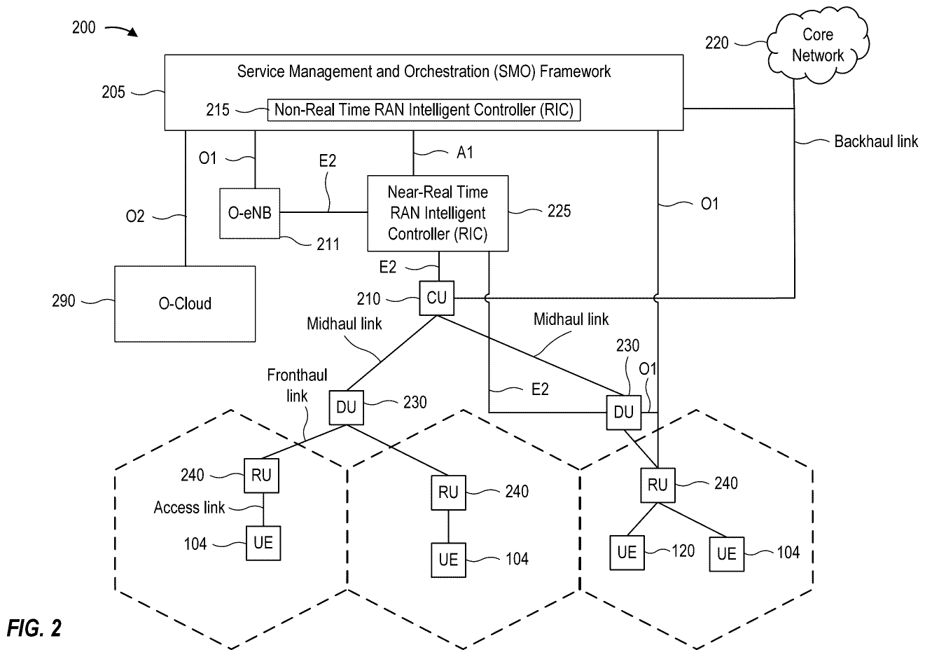

While BSs 102 are depicted in various aspects as unitary communications devices, BSs 102 may be implemented in various configurations. For example, one or more components of a base station may be disaggregated, including a central unit (CU), one or more DUs, one or more RUs, a Near-Real Time (Near-RT) RAN Intelligent Controller (RIC), or a Non-Real Time (Non-RT) RIC, to name a few examples. In another example, various aspects of a base station may be virtualized. A base station (e.g., BS 102) may include components that are located at a single physical location or components located at various physical locations. In examples in which a base station includes components that are located at various physical locations, the various components may each perform functions such that, collectively, the various components achieve functionality that is similar to a base station that is located at a single physical location. Implementing a base station in this fashion may provide efficiency gains by enabling cloud-based implementation of certain (e.g., non-time-sensitive) higher-layer functions while physical-layer or other lower-layer functions can be implemented at or in proximity to a geographic coverage area of a corresponding cell. In some aspects, a base station including components that are located at various physical locations may be referred to as having a disaggregated RAN architecture, such as an Open RAN (O-RAN) or Virtualized RAN (VRAN) architecture. FIG. 2 depicts and describes an example disaggregated RAN architecture.

Different BSs 102 within wireless communications network 100 may also be configured to support different radio access technologies, such as 3G, 4G, 5G, and/or 6G. For example, BSs 102 configured for 4G LTE (collectively referred to as Evolved Universal Mobile Telecommunications System (UMTS) Terrestrial Radio Access Network (E-UTRAN)) may interface with the EPC 160 through first backhaul links 132 (e.g., an S1 interface). BSs 102 configured for 5G (e.g., 5G NR or Next Generation RAN (NG-RAN)) may interface with 5GC 190 through second backhaul links 184. BSs 102 may communicate directly or indirectly (e.g., through the EPC 160 or the 5GC 190) with each other over third backhaul links 134 (e.g., an X2 or XN interface), which may be wired or wireless.

Wireless communications network 100 may subdivide the electromagnetic spectrum into various classes, bands, channels, or other features. In some aspects, the subdivision is provided based on wavelength and frequency, where frequency may also be referred to as a carrier, a subcarrier, a frequency channel, a tone, or a subband. For example, the Third Generation Partnership Project (3GPP) currently defines Frequency Range 1 (FR1) as including 410 MHz-7125 MHz, which is often referred to (interchangeably) as “Sub-6 GHz”. Similarly, 3GPP currently defines Frequency Range 2 (FR2) as including 24,250 MHz-71,000 MHz, which is sometimes referred to (interchangeably) as a “millimeter wave” (“mmW” or “mmWave”). In some cases, FR2may be further defined in terms of sub-ranges, such as a first sub-range FR2-1 including 24,250 MHz-52,600 MHz and a second sub-range FR2-2 including 52,600 MHz 71,000 MHz. A base station configured to communicate using mmWave/near mmWave radio frequency bands (e.g., a mmWave base station such as BS 180) may utilize beamforming (e.g., 182) with a UE (e.g., 104) to improve path loss and range.

A communications link 120 may be through one or more carriers, which may have different bandwidths (e.g., 5 MHz, 10 MHz, 15 MHz, 20 MHz, 100 MHz, 400 MHz, and/or other bandwidths), and which may be aggregated in various aspects. Carriers may or may not be adjacent to each other. Allocation of carriers may be asymmetric with respect to DL and UL (e.g., more or fewer carriers may be allocated for DL than for UL).

Communications using higher frequency bands may have higher path loss and a shorter range compared to lower frequency communications. Accordingly, certain base stations (e.g., base station 180 in FIG. 1) may utilize beamforming (indicated by reference number 182) with a UE 104 to improve path loss and range. For example, BS 180 and the UE 104 may each include a plurality of antennas, such as antenna elements, antenna panels, and/or antenna arrays to facilitate the beamforming. In some cases, BS 180 may transmit a beamformed signal to UE 104 in one or more transmit directions 182′. UE 104 may receive the beamformed signal from the BS 180 in one or more receive directions 182″. UE 104 may also transmit a beamformed signal to the BS 180 in one or more transmit directions 182″. BS 180 may also receive the beamformed signal from UE 104 in one or more receive directions 182′. BS 180 and UE 104 may perform beam training to determine suitable receive and transmit directions for each of BS 180 and UE 104. Notably, the transmit and receive directions for BS 180 may or may not be the same. Similarly, the transmit and receive directions for UE 104 may or may not be the same.

Wireless communications network 100 may include a Wi-Fi access point (AP) 150 in communication with Wi-Fi stations (STAs) 152 via communications links 154 in, for example, a 2.4 GHz and/or 5 GHz unlicensed frequency spectrum.

Certain UEs 104 may communicate with each other using device-to-device (D2D) communications link 158. In some examples, D2D communications link 158 may use one or more sidelink channels, such as a physical sidelink broadcast channel (PSBCH), a physical sidelink discovery channel (PSDCH), a physical sidelink shared channel (PSSCH), a physical sidelink control channel (PSCCH), and/or a physical sidelink feedback channel (PSFCH). D2D communications link 158 may be implemented using a variety of technologies, such as a radio access technology (e.g., 5G, ProSe sidelink), a WiFi technology, a Bluetooth technology, or the like.

EPC 160 may include various functional components, such as a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and/or a Packet Data Network (PDN) Gateway 172. MME 162 may be in communication with a Home Subscriber Server (HSS) 174. MME 162 is a control node that processes signaling between the UEs 104 and the EPC 160. Generally, MME 162 provides bearer and connection management.

Generally, user Internet protocol (IP) packets are transferred through Serving Gateway 166. Serving gateway 166 is connected to PDN Gateway 172. PDN Gateway 172 provides UE IP address allocation as well as other functions. PDN Gateway 172 and BM-SC 170 are connected to IP Services 176, which may include, for example, the Internet, an intranet, an IP Multimedia Subsystem (IMS), a Packet Switched (PS) streaming service, and/or other IP services.

BM-SC 170 may provide functions for MBMS user service provisioning and delivery. BM-SC 170 may serve as an entry point for content provider MBMS transmission, may be used to authorize and initiate MBMS Bearer Services within a public land mobile network (PLMN), and/or may be used to schedule MBMS transmissions. MBMS Gateway 168 may be used to distribute MBMS traffic to the BSs 102 belonging to a Multicast Broadcast Single Frequency Network (MBSFN) area broadcasting a particular service, and/or may be responsible for session management (start/stop) and for collecting eMBMS related charging information. 5GC 190 may include various functional components, such as an Access and Mobility Management Function (AMF) 192, other AMFs 193, a Session Management Function (SMF) 194, and a User Plane Function (UPF) 195. AMF 192 may be in communication with Unified Data Management (UDM) 196.

AMF 192 is a control node that processes signaling between UEs 104 and the 5GC 190. AMF 192 provides, for example, quality of service (QoS) flow and session management.

IP packets are transferred through UPF 195, which is connected to the IP Services 197. UPF 195 may provide UE IP address allocation as well as other functions for 5GC 190. IP Services 197 may include, for example, the Internet, an intranet, an IMS, a PS streaming service, and/or other IP services.

In various aspects, a network entity or network node can be implemented as an aggregated base station, as a disaggregated base station, a component of a base station, an integrated access and backhaul (IAB) node, a relay node, a core network entity, or a sidelink node, to name a few examples.

FIG. 2 depicts an example disaggregated base station 200 architecture. The disaggregated base station 200 architecture may include one or more CUs 210 that can communicate directly with a core network 220 or other CUs 210 via a backhaul link (such as backhaul link 134), or indirectly with the core network 220 through one or more disaggregated base station units (such as a Near-Real Time (Near-RT) RAN Intelligent Controller (RIC) 225 via an E2 link, a Non-Real Time (Non-RT) RIC 215 associated with a Service Management and Orchestration (SMO) Framework 205, or both). A CU 210 may communicate with one or more DUs 230 via respective midhaul links, such as an F1 interface. The DUs 230 may communicate with one or more RUs 240 via respective fronthaul links. The RUs 240 may communicate with respective UEs 104 via one or more radio frequency (RF) access links (such as communication link 120). In some implementations, a UE 104 may be simultaneously served by multiple RUs 240.

Each of the units, e.g., the CUs 210, the DUs 230, the RUs 240, as well as the Near-RT RICs 225, the Non-RT RICs 215 and the SMO Framework 205, may include one or more interfaces or be coupled to one or more interfaces configured to receive or transmit signals, data, or information (collectively, signals) via a wired or wireless transmission medium. Each of the units, or a processor or controller providing instructions to the interfaces of the units, can be configured to communicate with one or more of the other units via the transmission medium. For example, the units can include a wired interface configured to receive or transmit signals over a wired transmission medium to one or more of the other units. Additionally or alternatively, the units can include a wireless interface, which may include a receiver, a transmitter, or a transceiver (such as a RF transceiver), configured to receive or transmit signals, or both, over a wireless transmission medium.

In some aspects, the CU 210 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 210. The CU 210 may be configured to handle user plane functionality (e.g., Central Unit-User Plane (CU-UP)), control plane functionality (e.g., Central Unit-Control Plane (CU-CP)), or a combination thereof. In some implementations, the CU 210 can be logically split into one or more CU-UP units and one or more CU-CP units. The CU-UP unit can communicate bidirectionally with the CU-CP unit via an interface, such as the E1 interface when implemented in an O-RAN configuration. The CU 210 can be implemented to communicate with the DU 230 for network control and signaling.

The DU 230 may be or correspond to a logical unit that includes one or more base station functions to control the operation of one or more RUs 240. In some aspects, the DU 230 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3^{rd} Generation Partnership Project (3GPP). In some aspects, the DU 230 may further host one or more low PHY layers. Each layer (or module) can be implemented with an interface configured to communicate signals with other layers (and modules) hosted by the DU 230, or with the control functions hosted by the CU 210.

Lower-layer functionality can be implemented by one or more RUs 240. In some deployments, an RU 240, controlled by a DU 230, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 240 can be implemented to handle over the air (OTA) communications with one or more UEs 104. In some implementations, real-time and non-real-time aspects of control and user plane communications with the RU(s) 240 can be controlled by the corresponding DU 230. In some scenarios, this configuration can enable the DU(s) 230 and the CU 210 to be implemented in a cloud-based RAN architecture, such as a vRAN architecture.

The SMO Framework 205 may be configured to support RAN deployment and provisioning of non-virtualized and virtualized network elements. For non-virtualized network elements, the SMO Framework 205 may be configured to support the deployment of dedicated physical resources for RAN coverage requirements which may be managed via an operations and maintenance interface (such as an O1 interface). For virtualized network elements, the SMO Framework 205 may be configured to interact with a cloud computing platform (such as an open cloud (O-Cloud) 290) to perform network element life cycle management (such as to instantiate virtualized network elements) via a cloud computing platform interface (such as an O2 interface). Such virtualized network elements can include, but are not limited to, CUs 210, DUs 230, RUs 240 and Near-RT RICs 225. In some implementations, the SMO Framework 205 can communicate with a hardware aspect of a 4G RAN, such as an open eNB (O-eNB) 211, via an O1 interface. Additionally, in some implementations, the SMO Framework 205 can communicate directly with one or more DUs 230 and/or one or more RUs 240 via an O1 interface. The SMO Framework 205 also may include a Non-RT RIC 215 configured to support functionality of the SMO Framework 205.

The Non-RT RIC 215 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 225. The Non-RT RIC 215 may be coupled to or communicate with (such as via an A1 interface) the Near-RT RIC 225. The Near-RT RIC 225 may be configured to include a logical function that enables near-real-time control and optimization of RAN elements and resources via data collection and actions over an interface (such as via an E2 interface) connecting one or more CUs 210, one or more DUs 230, or both, as well as an O-eNB, with the Near-RT RIC 225.

In some implementations, to generate AI/ML models to be deployed in the Near-RT RIC 225, the Non-RT RIC 215 may receive parameters or external enrichment information from external servers. Such information may be utilized by the Near-RT RIC 225 and may be received at the SMO Framework 205 or the Non-RT RIC 215 from non-network data sources or from network functions. In some examples, the Non-RT RIC 215 or the Near-RT RIC 225 may be configured to tune RAN behavior or performance. For example, the Non-RT RIC 215 may monitor long-term trends and patterns for performance and employ AI/ML models to perform corrective actions through the SMO Framework 205 (such as reconfiguration via O1) or via creation of RAN management policies (such as A1 policies).

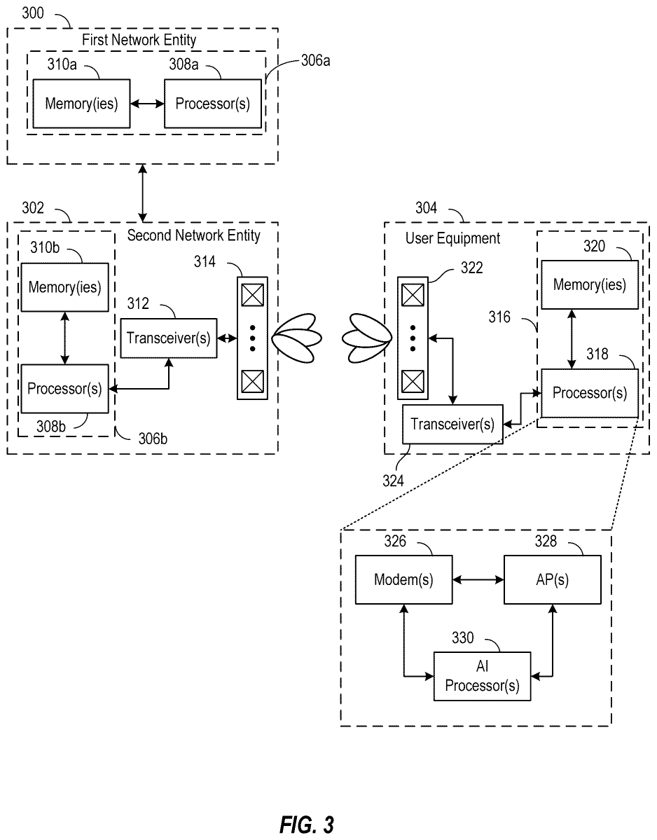

FIG. 3 depicts aspects of network entities 300 and 302 and a UE 304.

FIG. 3 includes a first network entity 300 and a second network entity 302. In some examples, first network entity 300 may be an example of a CU 210 or a DU 230. In some examples, second network entity 302 may be an example of a DU 230 or an RU 240. First network entity 300 and second network entity 302 may communicate with one another via a communications link, such as a midhaul link. In some examples, first network entity 300 and second network entity 302 may be implemented at a same BS (e.g., BS 102). For example, first network entity 300 and second network entity 302 may be co-located. In some other examples, first network entity 300 may be implemented separately from second network entity 302. For example, first network entity 300 may be implemented as a function (e.g., one or more processes) running on a server, such as in a cloud (e.g., a public or private cloud). As another example, first network entity 300 may be implemented as a virtual computing instance (e.g., virtual machine, container, etc.) or as a physical server.

First network entity 300 and second network entity 302 each include a processing system 306, illustrated as “processing system 306a” at first network entity 300 and “processing system 306b” at second network entity 302. For example, first network entity 300 and second network entity 302 may include one or more chips, system-on-chips (SoCs), system-in-packages (SiPs), chipsets, packages, or devices that individually or collectively constitute or comprise a processing system 306. A processing system 306 includes one or more processors 308 (illustrated as “processor(s) 308a” and “processor(s) 308b”) and one or more memories 310 (illustrated as “memory(ies) 310a” and “memory(ies) 310b”) coupled to the one or more processors 308. The one or more processors 308 may include one or multiple processors, microprocessors, processing units (such as central processing units (CPUs), graphics processing units (GPUs), neural processing units (NPUs) (also referred to as neural network processors or deep learning processors (DLPs)) and/or digital signal processors (DSPs)), processing blocks, application-specific integrated circuits (ASIC), programmable logic devices (PLDs) (such as field programmable gate arrays (FPGAs)), or other discrete gate or transistor logic or circuitry (any one or more of which may be generally referred to herein individually as a “processor” or collectively as “the processor” or “the processor circuitry”). One or more of the processors may be individually or collectively configurable or configured to perform various functions or operations described herein. A group of processors collectively configurable or configured to perform a set of functions may include a first processor configurable or configured to perform a first function of the set and a second processor configurable or configured to perform a second function of the set. In some other examples, each of a group of processors may be configurable or configured to perform a same set of functions.

In some aspects, the processing system 306 may perform processing (such as digital signal processing) of data, control information, or signals received or transmitted by a network entity. For example, the processing system 306 may include a coder, a decoder, a multiplexer, a demultiplexer, a transmit MIMO processor, a transmit processor, a receive processor, a receive MIMO detector, an automatic gain control component, or the like.

The one or more memories 310 may include one or more memory devices, memory blocks, memory elements or other discrete gate or transistor logic or circuitry, each of which may include tangible storage media such as random-access memory (RAM) or read-only memory (ROM), or combinations thereof (all of which may be generally referred to herein individually as “memories” or collectively as “the memory” or “the memory circuitry”). The one or more memories 310 may store data and program code for first network entity 300 and/or second network entity 302.

As further shown, second network entity 302 includes one or more transceivers 312 (illustrated as “transceiver(s) 312”). The one or more transceivers 312 may perform processing related to implementing physical layer (e.g., radio, air interface) communication with other devices such as UE 304. The one or more transceivers 312 may include one or more radio frequency (RF) components, such as an RF transceiver, a front-end module (e.g., an RF front-end (RFFE)), or the like. For example, the one or more transceivers 312 may include a transmit path (also referred to as a transmit chain), a receive path (also referred to as a receive chain), and/or an interface with one or more antennas 314.

The one or more antennas 314 may perform wireless transmission and reception of signals. The one or more antennas 314 may include, or may be included within, one or more antenna panels, one or more antenna groups, one or more sets of antenna elements, or one or more antenna arrays, among other examples. An antenna panel, an antenna group, a set of antenna elements, or an antenna array may include one or more antenna elements (within a single housing or multiple housings), a set of coplanar antenna elements, a set of non-coplanar antenna elements, or one or more antenna elements coupled with one or more transmission or reception components, such as one or more components of FIG. 3.

UE 304 may be an example of UE 104. As shown, UE 304 includes a processing system 316. For example, UE 304 may include one or more chips, SoCs, SiPs, chipsets, packages, or devices that individually or collectively constitute or comprise a processing system 316. A processing system 316 includes one or more processors 318, and one or more memories 320 coupled to the one or more processors 318. Further, UE 304 includes one or more antennas 322, one or more transceivers 324, and/or other components that enable wireless transmission and reception of data.

The one or more processors 318 may include one or multiple processors, microprocessors, processing units (such as CPUs, GPUs, NPUs (also referred to as neural network processors or DLPs) and/or DSPs), processing blocks, ASICs, PLDs (such as FPGAs), or other discrete gate or transistor logic or circuitry (any one or more of which may be generally referred to herein individually as a “processor” or collectively as “the processor” or “the processor circuitry”). One or more of the processors may be individually or collectively configurable or configured to perform various functions or operations described herein. In some aspects, the processing system 316 may perform processing (such as digital signal processing) of data, control information, or signals received or transmitted by a network entity. For example, the processing system 316 may include a coder, a decoder, a multiplexer, a demultiplexer, a transmit MIMO processor, a transmit processor, a receive processor, a receive MIMO detector, an automatic gain control component, or the like.

As shown, in some examples, the one or more processors 318 may include one or more modems 326, one or more application processors (APs) 328, one or more AI processors 330, a combination thereof, and/or another form of processor.

The one or more modems 326 may include a digital signal processor that converts information into a waveform for analog signal transmission (e.g., via modulation) and/or converts the waveform of a received signal into information (e.g., via demodulation). The one or more modems 326 may process information or waveforms in connection with signal transmission or reception. For example, the one or more modems 326 may include a coder, a decoder, a multiplexer, a demultiplexer, a transmit MIMO processor, a transmit processor, a receive processor, a receive MIMO detector, an automatic gain control component, or the like.

The one or more APs 328 may perform processing relating to an operating system and/or a higher layer application of the UE 304. For example, the one or more APs 328 may provide a higher-level operating system (HLOS), software, audio or video processing, graphics processing, or the like. In some examples, the one or more APs 328 may be a data source (e.g., for transmissions) or a data sink (e.g., for receptions).

The one or more transceivers 324 may perform processing related to implementing physical layer (e.g., radio, air interface) communication with other devices such as other UEs 304 or second network entity 302. The one or more transceivers 324 may include one or more RF components, such as an RF transceiver, a front-end module (e.g., an RFFE), or the like. For example, the one or more transceivers 324 may include a transmit path (also referred to as a transmit chain), a receive path (also referred to as a receive chain), and/or an interface with one or more antennas 322.

The one or more antennas 322 may perform wireless transmission and reception of signals. The one or more antennas 322 may include, or may be included within, one or more antenna panels, one or more antenna groups, one or more sets of antenna elements, or one or more antenna arrays, among other examples. An antenna panel, an antenna group, a set of antenna elements, or an antenna array may include one or more antenna elements (within a single housing or multiple housings), a set of coplanar antenna elements, a set of non-coplanar antenna elements, or one or more antenna elements coupled with one or more transmission or reception components, such as one or more components of FIG. 3.

For an example downlink transmission by second network entity 302, the processing system 306 (e.g., a transmit processor) may receive data and/or control information. The control information may be for the physical broadcast channel (PBCH), physical control format indicator channel (PCFICH), physical hybrid automatic repeat request (HARQ) indicator channel (PHICH), physical downlink control channel (PDCCH), group common PDCCH (GC PDCCH), and/or others. The data may be for the physical downlink shared channel (PDSCH), in some examples.

The processing system 306 (e.g., a transmit processor) may process (e.g., encode and symbol map) the data and control information to obtain data symbols and control symbols, respectively. The processing system 306 may also generate reference symbols, such as for the primary synchronization signal (PSS), secondary synchronization signal (SSS), PBCH demodulation reference signal (DMRS), or channel state information reference signal (CSI-RS).

The processing system 306 (e.g., a TX MIMO processor) may perform spatial processing (e.g., precoding) on the data symbols, the control symbols, and/or the reference symbols, if applicable, and may provide output symbol streams to one or more modulators of the processing system 306. The one or more modulators may process one or more respective output symbol streams to obtain an output sample stream. The one or more transceivers 312 may process (e.g., convert to analog, amplify, filter, and upconvert) the output sample stream to obtain a downlink signal. Second network entity 302 may transmit the downlink signal via the one or more antennas 314.

In order to receive the downlink transmission at UE 304 (or a sidelink transmission from another UE), the one or more antennas 322 may receive the downlink signal and may provide received signals to the one or more transceivers 324. The one or more transceivers 324 may condition (e.g., filter, amplify, downconvert, and digitize) the received signals to obtain input samples. The one or more transceivers 324 and/or the processing system 316 may further process the input samples to obtain received symbols.

The processing system 316 (e.g., modem 326, an RX MIMO detector) may obtain the received symbols, perform MIMO detection on the received symbols if applicable, and provide detected symbols. The processing system 316 (e.g., a modem 326, a receive processor) may process (e.g., de-interleave and decode) the detected symbols. The processing system 316 may provide decoded data for the UE 304 (e.g., to an AP 328) and/or decoded control information (e.g., to a controller/processor of the processing system 316).

For an example uplink transmission or a sidelink transmission from UE 304, the processing system 316 (e.g., modem 326, a transmit processor) may receive and process data and/or control information to obtain a set of symbols for transmission. The data may be for the physical uplink shared channel (PUSCH), and may be received from a data source such as the AP 328. The control information may be for the physical uplink control channel (PUCCH), and may be received, for example, from a controller/processor of the processing system 316. The processing system 316 (e.g., a modem 326, the transmit processor) may also generate reference symbols for a reference signal (e.g., for a sounding reference signal (SRS), a demodulation reference signal, a phase tracking reference signal, or the like). In some examples, the symbols and/or reference signals may be precoded by the processing system 316 (e.g., modem 326, a TX MIMO processor), further processed by the one or more transceivers 324 (e.g., for SC-FDM), and transmitted to second network entity 302.

At second network entity 302, the uplink signals from UE 304 may be received by the one or more antennas 314, conditioned by the one or more transceivers 312 (e.g., filtered, amplified, downconverted, and digitized), detected (e.g., by the processing system 306b such as a modem and/or an RX MIMO detector), and further processed by the processing system 306b (e.g., a modem and/or a receive processor) to obtain decoded data and control information sent by UE 304. The processing system 306b may provide the decoded data and the decoded control information (such as to a controller/processor of the processing system 306b, an AP, first network entity 300, or another entity).

In various aspects, a wireless communication device, such as first network entity 300, second network entity 302, BS 102, UE 104, or UE 304 may be described as sending, transmitting, obtaining, or receiving various types of data associated with the methods described herein. In these contexts, “transmitting” or “sending” may refer to various mechanisms of outputting data, such as outputting data from a processing system, one or more memories, one or more transceivers, one or more antennas, and/or other aspects described herein. For example, “sending” or “transmitting” by a device may include sending (such as wirelessly, via a wired connection, or both) to a recipient directly or via another device. As another example, “sending” or “transmitting” may include sending internally to a device (such as the UE 304, first network entity 300, or second network entity 302) by a process to memory. “Receiving” or “obtaining” may refer to various mechanisms of obtaining data, such as obtaining data from the processing system, one or more memories, one or more transceivers, one or more antennas, and/or other aspects described herein. For example, “receiving” or “obtaining” by a device may include obtaining (such as wirelessly, via a wired connection, or both) from a recipient directly or via another device. As another example, “receiving” or “obtaining” may include obtaining internally to a device (such as the UE 304, first network entity 300, or second network entity 302) by a process from memory. As used herein, “communicating” by a device may include sending, obtaining, receiving, and/or transmitting a communication. “Communicating” can refer to communication with another device or internal communication of the device.

In various aspects, the processing system 306 or the processing system 316 may include one or more AI processors (such as AI processor 330 of the processing system 316). An AI processor may perform AI processing. The AI processor may include AI accelerator hardware or circuitry such as one or more neural processing units (NPUs), one or more neural network processors, one or more tensor processors, one or more deep learning processors, etc. As an example, the AI processor may perform AI-based beam management, AI-based channel state feedback (CSF), AI-based antenna tuning, and/or AI-based positioning (e.g., non-line of sight positioning prediction). In some cases, at the UE 104, the AI processor may process feedback generated by the UE 304 (e.g., CSF) using hardware accelerated AI inferences and/or AI training. In some cases, at the second network entity 302, the AI processor may decode compressed CSF from the UE 304, for example, using a hardware accelerated AI inference associated with the CSF. In certain cases, the AI processor may perform certain RAN-based functions including, for example, network planning, network performance management, energy-efficient network operations, etc.

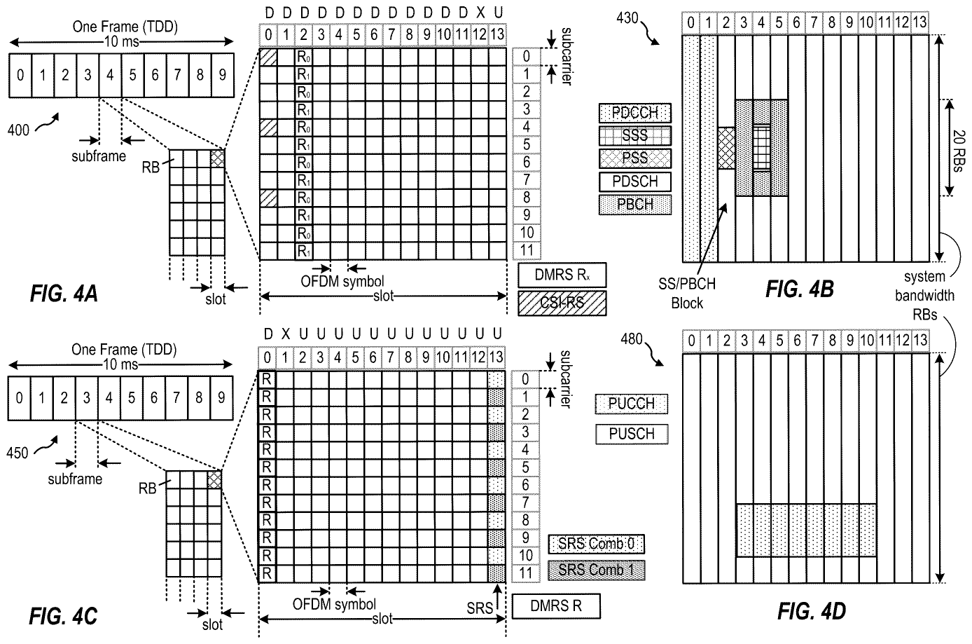

FIGS. 4A, 4B, 4C, and 4D depict aspects of data structures for a wireless communications network, such as wireless communications network 100 of FIG. 1.

FIG. 4A is a diagram 400 illustrating an example of a first subframe within a 5G (e.g., 5G NR) frame structure, FIG. 4B is a diagram 430 illustrating an example of DL channels within a 5G subframe, FIG. 4C is a diagram 450 illustrating an example of a second subframe within a 5G frame structure, and FIG. 4D is a diagram 480 illustrating an example of UL channels within a 5G subframe.

Wireless communications systems may utilize orthogonal frequency division multiplexing (OFDM) with a cyclic prefix (CP) on the uplink and downlink. Such systems may also support half-duplex operation using time division duplexing (TDD). OFDM and single-carrier frequency division multiplexing (SC-FDM) partition the system bandwidth (e.g., as depicted in FIGS. 4B and 4D) into multiple orthogonal subcarriers. One or more subcarriers may be modulated with data. Modulation symbols may be sent in the frequency domain with OFDM and/or in the time domain with SC-FDM.

In some examples, a wireless communications frame structure may be implemented using frequency division duplexing (FDD). In FDD, some subcarriers may be configured for DL communication, and other subcarriers (which may overlap in time with the DL subcarriers) may be configured for UL communication. In some other examples, wireless communications frame structures may be implemented using time division duplexing (TDD). In TDD, for a particular set of subcarriers, some subframes are configured for DL communication and other subframes are configured for UL communication.

In FIGS. 4A and 4C, the wireless communications frame structure is implemented using TDD. “D” indicates DL time resources, “U” indicates UL time resources, and “X” indicates flexible time resources for use or later reconfiguration for either DL or UL communication. UEs may be configured with a slot format through a received slot format indicator (SFI) (dynamically through DL control information (DCI), or semi-statically/statically through radio resource control (RRC) signaling). In the depicted examples, a 10 ms frame is divided into 10 equally sized 1 ms subframes. Each subframe may include one or more time slots. In some examples, each slot may include 12 or 14 symbols, depending on the cyclic prefix (CP) type (e.g., 12 symbols per slot for an extended CP or 14 symbols per slot for a normal CP). Subframes may also include mini-slots, which generally have fewer symbols than an entire slot. Other wireless communications technologies may have a different frame structure and/or different channels.

In certain aspects, the number of slots within a subframe (e.g., a slot duration in a subframe) is based on a numerology. A numerology may define a frequency domain subcarrier spacing and symbol duration, and may be configured for a given bandwidth part, carrier, cell, or network entity. In certain aspects, given a numerology μ, there are 2^{μ} slots per subframe. Thus, numerologies (μ) 0 to 6 may allow for 1, 2, 4, 8, 16, 32, and 64 slots, respectively, per subframe. In some cases, an extended CP (e.g., 12 symbols per slot) may be used with a specific numerology, such as numerology μ=2 allowing for 4 slots per subframe. The subcarrier spacing and symbol length/duration are a function of the numerology. The subcarrier spacing may be equal to 2^{μ}×15 kHz. As an example, the numerology μ=0 corresponds to a subcarrier spacing of 15 kHz, and the numerology μ=6 corresponds to a subcarrier spacing of 960 kHz. The symbol length/duration is inversely related to the subcarrier spacing. FIGS. 4A, 4B, 4C, and 4D provide an example of a slot format having 14 symbols per slot (e.g., a normal CP) and a numerology μ=2 with 4 slots per subframe. In such a case, the slot duration is 0.25 ms, the subcarrier spacing is 60 kHz, and the symbol duration is approximately 16.67μs.

As depicted in FIGS. 4A, 4B, 4C, and 4D, a resource grid may be used to represent the frame structure. Each time slot includes a resource block (RB) (also referred to as a physical RB (PRB)) that extends across, for example, 12 consecutive subcarriers. The resource grid is divided into multiple resource elements (REs). An RE may include a single subcarrier in the frequency domain and a single symbol in the time domain. The number of bits carried by each RE depends on the modulation scheme including, for example, quadrature phase shift keying (QPSK) or quadrature amplitude modulation (QAM).

As illustrated in FIG. 4A, some of the REs carry reference (pilot) signals (shown as “RS”) for a UE (e.g., UE 104 of FIGS. 1 and 3). The RS may include a demodulation RS (DMRS) and/or a channel state information reference signals (CSI-RS) for channel estimation at the UE. The RS may additionally or alternatively include a beam measurement RS (BRS), a beam refinement RS (BRRS), and/or a phase tracking RS (PT-RS).

FIG. 4B illustrates an example of various DL channels within a subframe of a frame. The physical downlink control channel (PDCCH) carries DCI within one or more control channel elements (CCEs), each CCE including, for example, nine RE groups (REGs), each REG including, for example, four consecutive REs in an OFDM symbol.

A primary synchronization signal (PSS) may be within symbol 2 of particular subframes of a frame. The PSS is used by a UE (e.g., 104 of FIGS. 1 and 3) to determine subframe/symbol timing and a physical layer identity.

A secondary synchronization signal (SSS) may be within symbol 4 of particular subframes of a frame. The SSS is used by a UE to determine a physical layer cell identity group number and radio frame timing.

Based on the physical layer identity and the physical layer cell identity group number, the UE can determine a physical cell identifier (PCI). Based on the PCI, the UE can determine the locations of the aforementioned DMRS. The physical broadcast channel (PBCH), which carries a master information block (MIB), may be logically grouped with the PSS and SSS to form a synchronization signal (SS)/PBCH block (SSB), and in some cases, referred to as a synchronization signal block (SSB). The MIB provides a number of RBs in the system bandwidth and a system frame number (SFN). The physical downlink shared channel (PDSCH) carries user data, broadcast system information not transmitted through the PBCH such as system information blocks (SIBs), and/or paging messages.

As illustrated in FIG. 4C, some of the REs carry DMRS (indicated as “R” for one particular configuration, but other DMRS configurations are possible) for channel estimation at the base station. The UE may transmit DMRS for the PUCCH and DMRS for the PUSCH. The PUSCH DMRS may be transmitted, for example, in the first one or two symbols of the PUSCH. The PUCCH DMRS may be transmitted in different configurations depending on whether short or long PUCCHs are transmitted and depending on the particular PUCCH format used. UE 104 may transmit sounding reference signals (SRS). The SRS may be transmitted, for example, in the last symbol of a subframe. The SRS may have a comb structure, and a UE may transmit SRS on one of the combs. The SRS may be used by a base station for channel quality estimation to enable frequency-dependent scheduling on the UL.

FIG. 4D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and HARQ ACK/NACK feedback. The PUSCH carries data, and may additionally be used to carry a buffer status report (BSR), a power headroom report (PHR), and/or UCI.

### Example Sidelink Communications

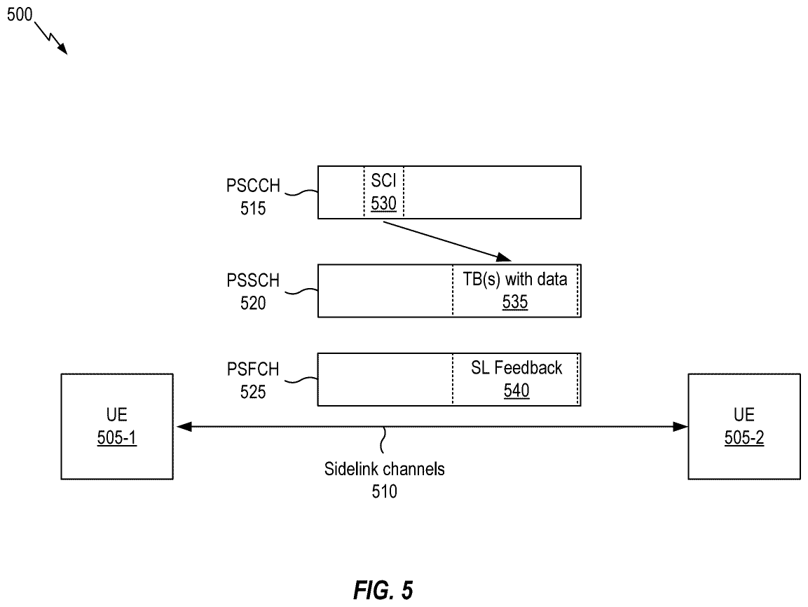

FIG. 5 depicts an example 500 of sidelink communications.

As shown in FIG. 5, a first UE 505-1 may communicate with a second UE 505-2 (and one or more other UEs) via one or more sidelink channels 510. The UEs 505-1 and 505-2 may communicate using the one or more sidelink channels 510 for P2P communications, D2D communications, V2X communications (e.g., which may include V2V communications, vehicle-to-infrastructure (V2I) communications, and/or vehicle-to-pedestrian (V2P) communications) and/or mesh networking. In some aspects, the UEs (e.g., UE 505-1 and/or UE 505-2) may be an example of UE 104 depicted and described with respect to FIG. 1 or the UE 304 depicted and described with respect to FIG. 3. However, in other aspects, the UEs 505-1 or 505-2 may be another type of wireless communications device, such as those described herein. In some aspects, the one or more sidelink channels 510 may use a PC5 interface and/or may operate in a high frequency band (e.g., the 5.9 GHz band). Additionally, or alternatively, the UEs 505-1 or 505-2 may synchronize timing of transmission time intervals (TTIs) (e.g., frames, subframes, slots, or symbols) using global navigation satellite system (GNSS) timing.

As further shown in FIG. 5, the one or more sidelink channels 510 may include a physical sidelink control channel (PSCCH) 515, a physical sidelink shared channel (PSSCH) 520, and/or a physical sidelink feedback channel (PSFCH) 525. The PSCCH 515 may be used to communicate control information, similar to a physical downlink control channel (PDCCH) and/or a physical uplink control channel (PUCCH) used for cellular communications with a BS 102 via an access link or an access channel. The PSSCH 520 may be used to communicate data, similar to a physical downlink shared channel (PDSCH) and/or a physical uplink shared channel (PUSCH) used for cellular communications with a BS 102 via an access link or an access channel. For example, the PSCCH 515 may carry sidelink control information (SCI) 530, which may indicate various control information used for sidelink communications, such as one or more resources (e.g., time resources, frequency resources, and/or spatial resources) where a transport block (TB) 535 may be carried on the PSSCH 520. The TB 535 may include data. The PSFCH 525 may be used to communicate sidelink feedback 540, such as hybrid automatic repeat request (HARQ) feedback (e.g., acknowledgement or negative acknowledgement (ACK/NACK) information), transmit power control (TPC), and/or a scheduling request (SR).

In some aspects, the SCI 530 may include multiple communications in different stages, such as a first stage SCI (SCI-1) and a second stage SCI (SCI-2). The SCI-1 may be transmitted on the PSCCH 515. The SCI-2 may be transmitted on the PSSCH 520. The SCI-1 may include, for example, an indication of one or more resources (e.g., time resources, frequency resources, and/or spatial resources) on the PSSCH 520, information for decoding sidelink communications on the PSSCH, a quality of service (QoS) priority value, a resource reservation period, a PSSCH DMRS pattern, an SCI format for the SCI-2, a beta offset for the SCI-2, a quantity of PSSCH DMRS ports, and/or a modulation and coding scheme (MCS). The SCI-2 may include information associated with data transmissions on the PSSCH 520, such as a HARQ process ID, a new data indicator (NDI), a source identifier, a destination identifier, and/or a channel state information (CSI) report trigger.

In some aspects, the one or more sidelink channels 510 may use resource pools. For example, a scheduling assignment (e.g., included in SCI 530) may be transmitted in sub-channels using specific resource blocks (RBs) across time. In some aspects, data transmissions (e.g., on the PSSCH 520) associated with a scheduling assignment may occupy adjacent RBs in the same subframe as the scheduling assignment (e.g., using frequency division multiplexing). In some aspects, a scheduling assignment and associated data transmissions are not transmitted on adjacent RBs.

In some aspects, a UE 505-1 or 505-2 may operate using a transmission mode where resource selection and/or scheduling is performed by the UE 505-1 or 505-2 (e.g., rather than a BS 102). In some aspects, the UE 505-1 or 505-2 may perform resource selection and/or scheduling by sensing channel availability for transmissions. For example, the UE 505-1 or 505-2 may measure a received signal strength indicator (RSSI) parameter (e.g., a sidelink-RSSI (S-RSSI) parameter) associated with various sidelink channels, may measure a reference signal received power (RSRP) parameter (e.g., a PSSCH-RSRP parameter) associated with various sidelink channels, and/or may measure a reference signal received quality (RSRQ) parameter (e.g., a PSSCH-RSRQ parameter) associated with various sidelink channels, and may select a channel for transmission of a sidelink communication based at least in part on the measurement(s).

Additionally, or alternatively, the UE 505-1 or 505-2 may perform resource selection and/or scheduling using SCI 530 received in the PSCCH 515, which may indicate occupied resources and/or channel parameters. Additionally, or alternatively, the UE 505-1 or 505-2 may perform resource selection and/or scheduling by determining a channel busy rate (CBR) associated with various sidelink channels, which may be used for rate control (e.g., by indicating a maximum number of resource blocks that the UE 505-1 or 505-2 can use for a particular set of subframes).

In the transmission mode where resource selection and/or scheduling is performed by a UE 505-1 or 505-2, the UE 505-1 or 505-2 may generate sidelink grants, and may transmit the grants in SCI 530. A sidelink grant may indicate, for example, one or more parameters (e.g., transmission parameters) to be used for an upcoming sidelink transmission, such as one or more resource blocks to be used for the upcoming sidelink transmission on the PSSCH 520 (e.g., for TBs 535), one or more subframes to be used for the upcoming sidelink transmission, and/or an MCS to be used for the upcoming sidelink transmission. In some aspects, a UE 505-1 or 505-2 may generate a sidelink grant that indicates one or more parameters for semi-persistent scheduling (SPS), such as a periodicity of a sidelink transmission. Additionally, or alternatively, the UE 505-1 or 505-2 may generate a sidelink grant for event-driven scheduling, such as for an on-demand sidelink message.

FIG. 5 is provided as an example. Other examples may differ from what is described with respect to FIG. 5.

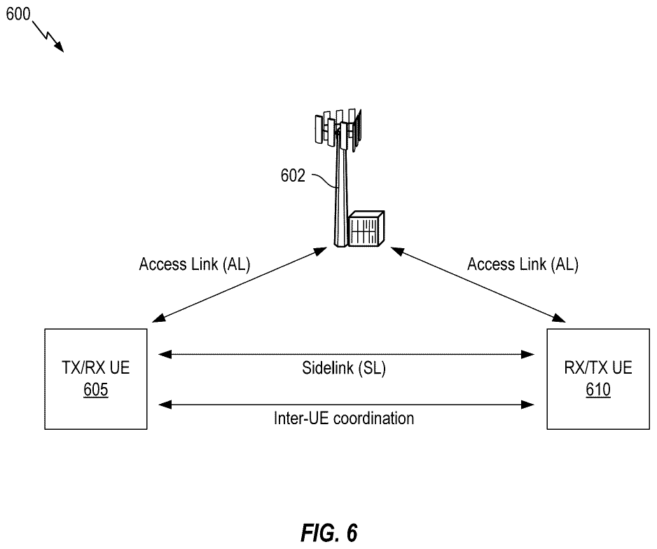

FIG. 6 depicts an example 600 of sidelink communications and access link communications. As shown in FIG. 6, a TX/RX UE 605 and an RX/TX UE 610 may communicate with one another via a sidelink, as described above in connection with FIG. 5. As further shown, in some sidelink modes, a BS 602 may communicate with the TX/RX UE 605 via a first access link. Additionally, or alternatively, in some sidelink modes, the BS 602 may communicate with the RX/TX UE 610 via a second access link. In some aspects, the TX/RX UE 605 and/or the RX/TX UE 610 may each be an example of UE 104 depicted and described with respect to FIG. 1 or the UE 304 depicted and described with respect to FIG. 3. Similarly, the BS 602 may be an example of the BS 102 depicted and described with respect to FIG. 1, the first network entity 300 or the second network entity 302 depicted and described with respect to FIG. 3, or a disaggregated base station depicted and described with respect to FIG. 2. However, in other aspects, the TX/RX UE 605 and/or the RX/TX UE 610 may be another type of wireless communications device and the BS 602 may be another type of network entity or network node, such as those described herein. Thus, a direct link between UEs 605, 610 (e.g., via a PC5 interface) may be referred to as a sidelink, and a direct link between a BS 602 and a UE 605, 610 (e.g., via a Uu interface) may be referred to as an access link. Sidelink communications may be transmitted via the sidelink, and access link communications may be transmitted via the access link. An access link communication may be either a downlink communication (from a BS 602 to a UE 605, 610) or an uplink communication (from a UE 605, 610 to a BS 602).

FIG. 6 is provided as an example. Other examples may differ from what is described with respect to FIG. 6.

### Example Ofdm Communications System

Certain wireless communication systems may be implemented using orthogonal frequency division multiplexing (OFDM). The fundamental concept of a multicarrier system (such as OFDM) is the division of a data stream into several subcarriers. An OFDM signal may be considered a bundle of subcarriers transmitted across a carrier bandwidth. Each of the subcarriers conveys information by modulating the phase and/or the amplitude of the subcarrier over a particular symbol duration. For example, each subcarrier may use either phase-shift-keying (PSK) or quadrature-amplitude-modulation (QAM) to convey information.

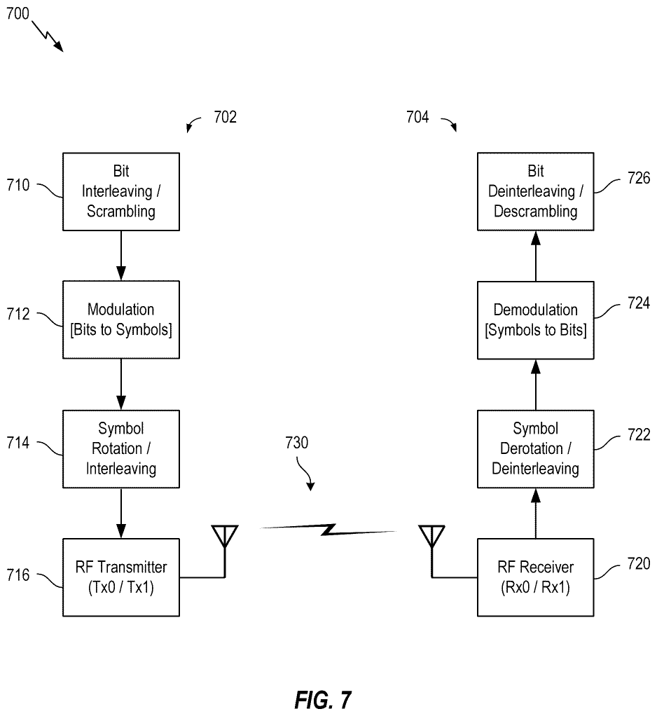

FIG. 7 depicts an example wireless communications system 700 including an example transmitter chain and an example receiver chain for OFDM communications between a transmitter 702 and a receiver 704 over a wireless communications channel (hereinafter “the channel 730”). In some aspects, the transmitter 702 and receiver 704 may be examples of UE 104 depicted and described with respect to FIG. 1 or the UE 304 depicted and described with respect to FIG. 3. However, in other aspects, transmitter 702 and receiver 704 may be another type of wireless communications device, such as those described herein. Note that any operations or signaling illustrated with dashed lines may indicate that that operation or signaling is an optional or alternative example. In an OFDM context, a transmitter chain is a series of operations applied to data to generate a signal for transmission of the data over a wireless channel. Also in the OFDM context, a receiver chain is a series of operations applied to a received signal to extract data from the received signal.

Physical layer processing of signals in the wireless network typically includes a bit interleaving stage. Interleaving involves shuffling a bit stream according to a pattern, such as by reading the bits into a table row by row, then reading out of the table column by column. This bit interleaving may distribute possible bit errors across the input of the channel decoder at the receiver and avoid bursts of contiguous bit errors, which increases the performance of the channel decoder.

Another typical stage in the physical layer processing is bit scrambling. Scrambling is a binary bit-level processing applied to the transmission rate signal in order to make the resulting binary sequence appear more random. In this process, a “pseudo-random” sequence is combined with the bit stream using shift registers or a function such as exclusive-OR (XOR), with the intent of randomizing the bit stream in a controlled way due to the applied sequence being selected and known to both transmitter and receiver. Scrambling is generally meant to increase security and also to randomize the interference that may be created in the channel and thus decrease the impact of such interference on the channel.

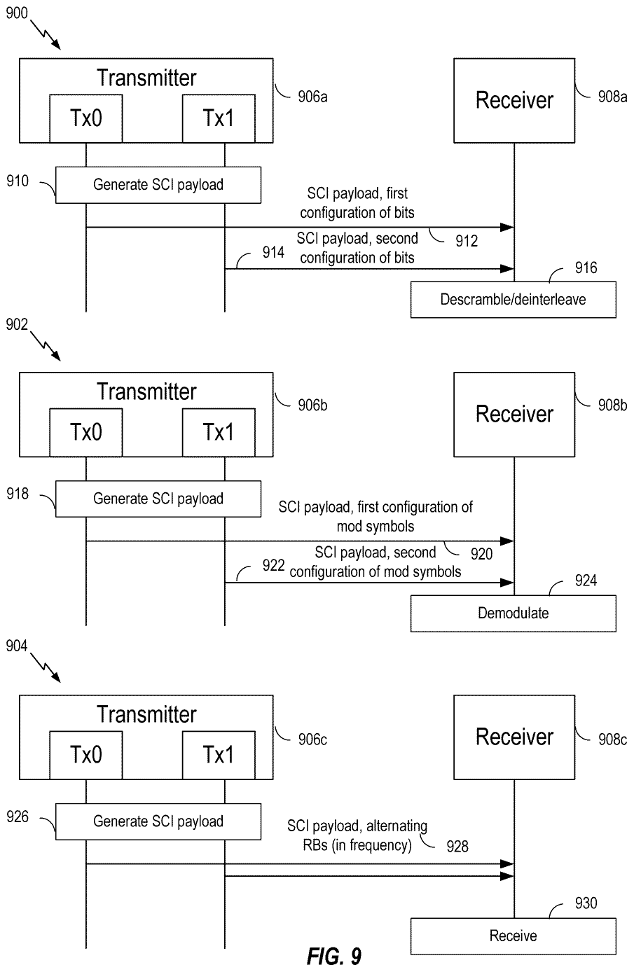

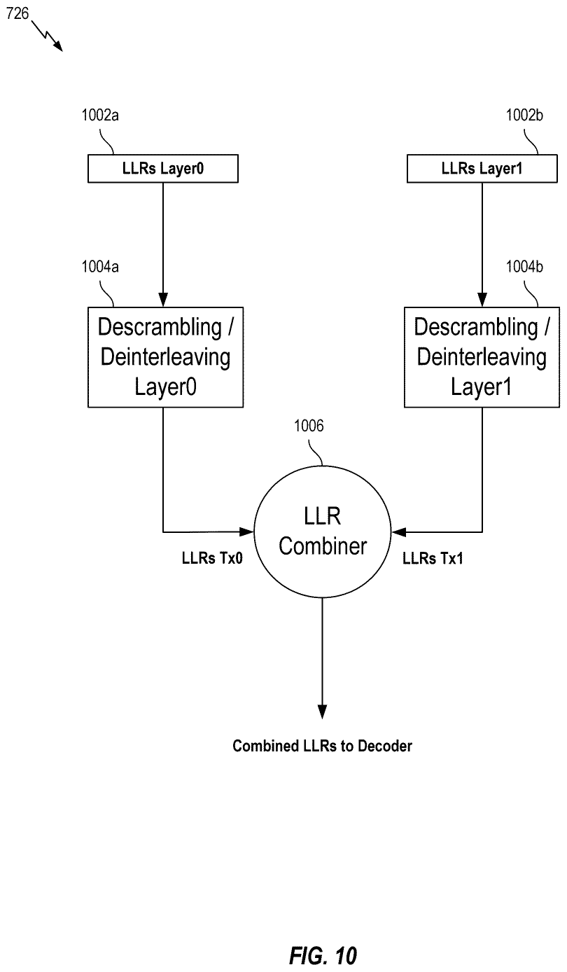

In this example, the transmitter 702 interleaves and/or scrambles the bits at block 710. For instance, the transmitter 702 may use an interleaving pattern where an input bit stream is read into a table row by row and read out of the table column by column, thus modifying the order of the bits in the output bit stream. An interleaving pattern may indicate how the input bit stream is interleaved to create the output bit stream. In another example, at block 706, the transmitter 702 may scramble the bits to randomize the bit stream, such as by applying a scrambling sequence (e.g., a pseudo-random sequence) with an exclusive-OR (XOR) function to the bit stream. Such processes typically harden the bit stream against interference and simplify error correction when known sequences and patterns are applied at the transmitter and reversed at the receiver, as described below with respect to FIGS. 9 and 10.

Certain wireless communications systems may also apply digital modulation to convey information via radio waves. Digital modulation is the process by which digital information (e.g., a bit stream) is converted to certain waveforms that correspond to symbols. A symbol may be a set of bits from a set of symbols that form an alphabet. Each symbol may correspond to a specific waveform, for example, according to a digital modulation scheme, such as quadrature phase shift keying (QPSK) or quadrature amplitude modulation (QAM). As an example, the waveforms of QPSK can have four different phase shift states (e.g., phase shifts of 45°, 135°, 225°, and 315°) at the same amplitude, and each phase shift state corresponds to a different symbol (e.g., a bit combination of ‘00’, ‘01’, ‘10’, or ‘11’). In certain cases, the symbols of an alphabet may be represented as points of a constellation, for example, in a two-dimensional coordinate system. Each of the points of the constellation may represent a symbol, such that the polar coordinates of each point (e.g., the magnitude and angle of a phase notation) represent the amplitude and phase of the corresponding symbol waveform.

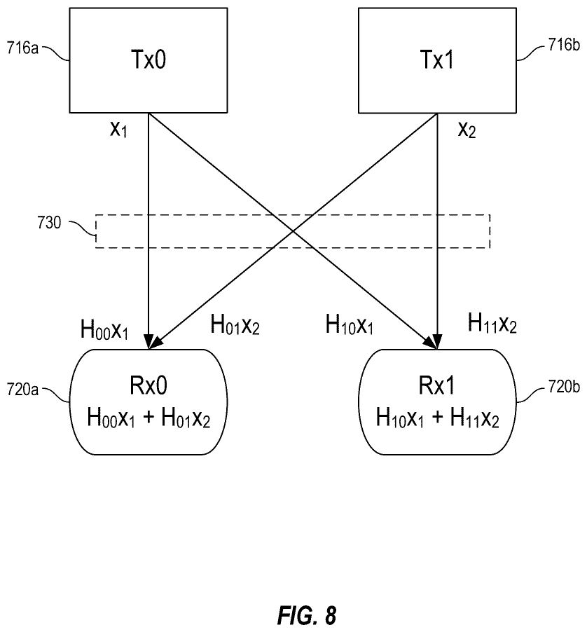

The transmitter 702 modulates a bit stream into symbols according to a digital modulation scheme (e.g., QPSK or QAM) at block 712. A separate phase rotation may be applied to the resulting symbols at block 714 or the symbols may be processed using a separate symbol interleaving pattern, as described with respect to FIG. 10. The resulting signal can be mixed to a RF carrier frequency and output by an RF transmitter (e.g., an RF front-end) at block 716, as described with respect to FIG. 8.

The receiver 704 receives the RF signal and then filters and converts the RF signal to a baseband signal via an RF receiver (e.g., an RF front-end) at block 720. The RF signal may be affected by the channel 730, for example, due to various signal propagation effects including path loss, multipath effects, fading, Doppler effects, etc. The baseband signal is converted from an analog signal to a digital signal for demodulation. The digital signal may correspond to the time-domain waveform of the symbols.

At block 722 and block 724, the receiver 704 recovers the transmitted bit stream, for example, by first reversing the phase rotation and/or interleaving pattern that may have been applied to the modulation symbols at the transmitter 702 and then converting the symbols to bits. For each of the received symbols, the phase and amplitude may be represented as a constellation point. The constellation points of the symbols may form a constellation of complex values representative of a codeword (e.g., a combination of one or more bits). The constellation points are demapped (demodulated or decoded) to transform the constellation points into the codeword or decoded information. As the subcarriers are subjected to various signal propagation effects through the channel 730, the constellation points may have errors (e.g., phase and/or magnitude errors) relative to the expected position of the constellation points. The receiver may perform any of various decoding operations to estimate the data conveyed in the constellation points, such as hard decision decoding or soft decision decoding.

As an example, each received constellation point may be compared to a reference constellation point (for example, using an MMSE-based demodulator or a maximum likelihood-based demodulator). The receiver 704 may determine the reference constellation point that is closest to the received point, and the codeword that belongs to the closest reference constellation point may be assigned to the received point. The decoded information may include the one or more codewords decoded among the constellation points for the symbols. The information that is encoded at the transmitter and successfully decoded at the receiver may be called mutual information, which may be indicative of the capacity of the channel 730, for example, the data rate or throughput rate. The various types of decoding operations (e.g., a specific type of FFT, channel estimation, channel equalization, and/or demodulation) may be selected based on the performance of the corresponding operation, such as latency (e.g., computation time), memory usage, number of computations performed, etc.

The receiver 704 descrambles and/or deinterleaves the bits at 726, as described herein with respect to FIG. 8, and forwards the result to the decoder.

Note that the process flow illustrated in FIG. 7 is an example of physical layer processing in sidelink communications. Note that the process flow illustrated in FIG. 7 is described herein to facilitate an understanding of physical layer processing in sidelink communications, and aspects of the present disclosure may be performed in various manners via alternative or additional signaling and/or operations. In certain aspects, the operations and/or signaling of FIG. 7 may occur in an order different from that described or depicted, and various actions, operations, and/or signaling may be added, omitted, or combined.

### Aspects Related to Physical Layer Processing in Sidelink Transmission

FIG. 8 depicts a channel model for communications between UEs, e.g., TX/RX UE 605 and RX/TX UE 610 of FIG. 6, in the channel 730 using two MIMO layers and two antenna ports, e.g., two-layer PSSCH communication. The channel model of FIG. 8 is based on transmit antenna port Tx0 and transmit antenna port Tx1. The generated signals, indicated by arrows from Tx0 and Tx1, are transmitted from each of the antenna ports over the channel 730 and received at receive antenna ports Rx0 and Rx1. The wireless channel is generally represented by a channel matrix denoted H. The effect of the channel 730 may be expressed as a factor depending on the signal path, e.g., H₀₀, H₀₁, H₁₀, or H₁₁. As a result, the cumulative signal received at receive antenna port Rx0 may be expressed as H₀₀x₁+H₀₁x₂ and the signal received at receive antenna port Rx1 may be expressed as H₁₀x₁+H₁₁x₂ (a noise component is omitted in each of these expressions). These expressions indicate that each of the transmitted signals are received at each receiver and the channel effects may be different between transmitter and receiver from one transmitter/receiver antenna pair to the next.

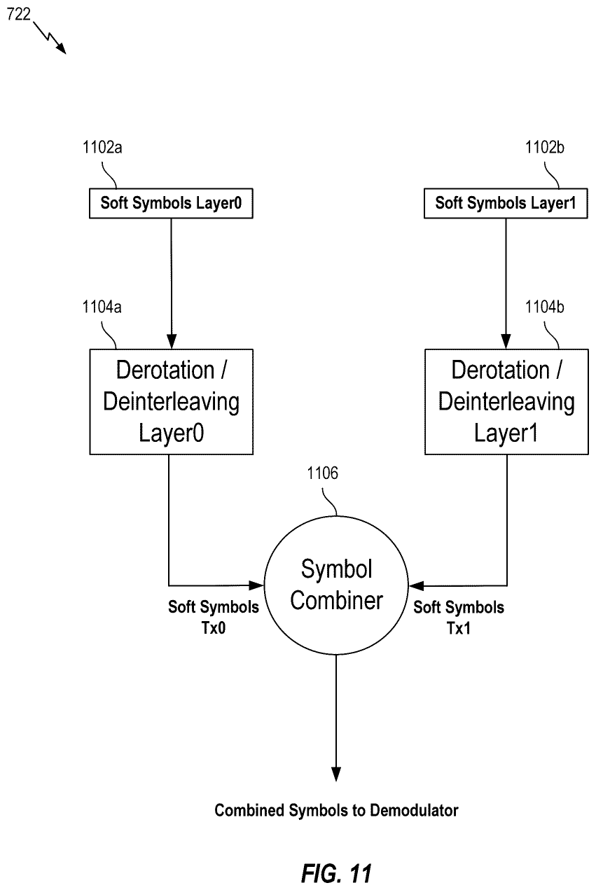

In PSSCH communications using two MIMO layers, the SCI-2 information may be duplicated at Tx0 and Tx1. This allows common channel estimation to be used for PSSCH and SCI-2, but may result in identical signals being transmitted from the two antenna ports. Since this identical transmission may cause the formation of nulls in the radiation pattern of the two antennas, it may be useful to separately modify the physical signals prior to transmission. Aspects described herein accomplish these modifications by using different configurations of bits, e.g., by applying distinct interleaving patterns or distinct pseudo-random scrambling sequences to the individual bit streams, at each antenna port, for example at 710 of FIG. 7. Another option, as described with respect to FIG. 11 below, is to use different configurations of modulation symbols, e.g., by applying distinct phase rotation sequences or interleaving patterns to the symbols that are formed in the modulation process, at each antenna port, for example at 714 of FIG. 7. A third option may be to alternate the resource blocks sent to each antenna port in the frequency domain (for example, at 716 of FIG. 7). The techniques described herein cause the physical signal to be different on each antenna even if the information sent by the sidelink transmission, e.g., SCI-2 or the second stage of SCI information, is still duplicated to the antennas.

FIG. 9 depicts process flows 900, 902, and 904 for communications in a network between a transmitter UE 906a, 906b, 906c and a receiver UE 908a, 908b, 908c, respectively. In certain aspects, the transmitter UE 906a, 906b, 906c and the receiver UE 908a, 908b, 908c may be examples of UE 104 depicted and described with respect to FIG. 1 the UE 304 depicted and described with respect to FIG. 3, UE 505-1, UE 505-2, TX/RX UE 605, or RX/TX UE 610. However, in other aspects, the transmitter UE 906a, 906b, 906c and/or the receiver UE 908a, 908b, 908c may be another type of wireless communications device, such as those described herein. Note that any operations or signaling illustrated with dashed lines may indicate that that operation or signaling is an optional or alternative example.

As shown in FIG. 9, process flow 900 illustrates physical layer processing of a MIMO transmission between a transmitter UE 906a and a receiver UE 908a. At 910, the transmitter UE 906a generates an SCI payload for sidelink transmission, such as SCI-2 (e.g., a second stage of SCI) information in PSSCH. In process flow 900, transmitter UE 906a generates a first configuration of bits for the signal mapped to antenna port Tx0 and a second configuration of bits for the signal mapped to antenna port Tx1. In some aspects, the first configuration of bits may be associated with a first scrambling sequence (e.g., generated using a first scrambling sequence) and the second configuration of bits may be associated with a second scrambling sequence (e.g., generated using a second scrambling sequence). This may be referred to as the first configuration of bits and the second configuration of bits having distinct scrambling sequences. In some aspects, the first configuration of bits may be associated with a first bit interleaving pattern (e.g., generated using a first bit interleaving pattern) and the second configuration of bits may be associated with a second bit interleaving pattern (e.g., generated using a second bit interleaving pattern). This may be referred to as the first configuration of bits and the second configuration of bits having distinct bit interleaving patterns. Interleaving patterns and scrambling sequences are described with respect to block 710 above. As a result, the SCI payload 912 that is transmitted by antenna port Tx0 is not identical to the SCI payload 914 that is transmitted by antenna port Tx1, thereby reducing the occurrence of nulling.

At 916, receiver UE 908a descrambles and/or deinterleaves SCI payloads 912, 914 according to the first and second configurations of bits, e.g., using the distinct scrambling sequences or interleaving patterns of block 910. Physical layer processing in the receiver chain continues at the receiver UE 908a as described with respect to FIGS. 7 and 10.

Also shown in FIG. 9, process flow 902 illustrates physical layer processing of a MIMO transmission between a transmitter UE 906b and a receiver UE 908b. At 918, the transmitter UE 906b generates a SCI payload for sidelink transmission, such as SCI-2 (e.g., a second stage of SCI) information in PSSCH. In process flow 902, transmitter UE 906a generates a first configuration of modulation symbols for the signal mapped to antenna port Tx0 and a second configuration of modulation symbols for the signal mapped to antenna port Tx1. In some aspects, the first configuration of modulation symbols may be associated with a first sequence of phase rotations (e.g., generated using a first phase rotation) and the second configuration of modulation symbols may be associated with a second sequence of phase rotations (e.g., generated using a second phase rotation), where each sequence of phase rotations may also be referred to as a set of phase rotations. For example, a sequence of phase rotations (or set of phase rotations) may indicate a respective phase rotation to be applied to each modulation symbol of a set of modulation symbols. This may be referred to as the first configuration of modulation symbols and the second configuration of symbols having distinct phase rotations. In some aspects, the first configuration of modulation symbols may be associated with a first symbol interleaving pattern (e.g., generated using a first symbol interleaving pattern) and the second configuration of modulation symbols may be associated with a second symbol interleaving pattern (e.g., generated using a second symbol interleaving pattern). This may be referred to as the first configuration of modulation symbols and the second configuration of modulation symbols having distinct symbol interleaving patterns. Interleaving patterns and phase rotations are described with respect to block 714 above. As a result, the SCI payload 920 that is transmitted by antenna port Tx0 is not identical to the SCI payload 922 that is transmitted by antenna port Tx1, thereby reducing the occurrence of nulling.

At 924, receiver UE 908b demodulates SCI payloads 920, 922 according to the first and second configurations of modulation symbols, e.g., using the distinct phase rotations or symbol interleaving patterns of block 918. Physical layer processing in the receiver chain continues at the receiver UE 908a as described with respect to FIGS. 7 and 11.

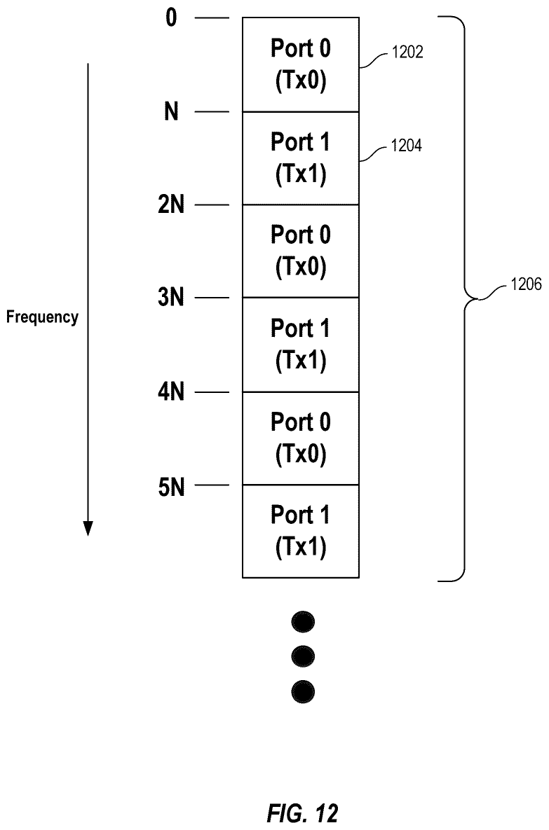

Also shown in FIG. 9, process flow 904 illustrates physical layer processing of a MIMO transmission between a transmitter UE 906c and a receiver UE 908c. At 926, the transmitter UE 906c generates the SCI payload for sidelink transmission, such as SCI-2 (e.g., a second stage of SCI) information in PSSCH. In process flow 904, transmitter UE 906c generates a first set of resource blocks for the signal mapped to antenna port Tx0 and a second set of resource blocks for the signal mapped to antenna port Tx1. In some aspects, the first set of resource blocks may be associated with the first N resource blocks of the SCI payload 928, as shown in FIG. 12 below using the frequency domain, and the second set of resource blocks may be associated with the next N resource blocks of the SCI payload 928, as also shown in FIG. 12 below using the frequency domain. In some aspects, the first and second sets of resource blocks may also be interleaved for transmission to receiver UE 908c. As a result of the transmission pattern, the signal that is transmitted by antenna port Tx0 is not identical to the signal that is transmitted by antenna port Tx1, thereby reducing the occurrence of nulling.

At 930, receiver UE 908c receives the alternating resource blocks and reconstructs the signal according to the known transmission pattern. Physical layer processing in the receiver chain continues at the receiver UE 908c as described with respect to FIG. 7.

FIG. 10 depicts a detailed process flow for the descrambling/deinterleaving block 726 of FIG. 7 (and corresponding block 916 of FIG. 9) in the case of two-layer MIMO, e.g., two-layer PSSCH transmission. The operations of FIG. 10 may be performed by a UE, such as UE 104, UE 304, UE 505-1, UE 505-2, TX/RX UE 605, RX/TX UE 610, transmitter 906, or receiver 908. In FIG. 10, the UE may perform soft decoding (e.g., soft-decision decoding where bit reliabilities are incorporated into the decoding process) on the demodulated signals, for example, via a log-likelihood ratio (LLR) combiner 1006 that combines the demodulated signals received on each antenna port. The UE may feed the combined information to a decoder that outputs the decoded payload. Accordingly, the UE may use multiple receive antenna ports to receive sidelink communications carrying a single codeword that is layer-mapped across the MIMO layers supported by and/or configured at the UE. The UE may determine LLRs 1002a based on a first MIMO layer (MIMO Layer0) at 1004a and may determine LLRs 1002b based on a second MIMO layer (MIMO Layer1) at 1004b. The UE may perform descrambling and/or deinterleaving may be performed separately for each layer according to the interleaving pattern and/or scrambling sequence used in block 710, as described in FIG. 7. This allows the bit streams to be reconstructed and combined to form a combined LLR at 1006 to send to the decoder.

FIG. 11 depicts a detailed process flow for the symbol derotation/deinterleaving block 722 of FIG. 7 (and corresponding block 924 of FIG. 9) in the case of two-layer MIMO, e.g., two-layer PSSCH transmission. The operations of FIG. 11 may be performed by a UE, such as UE 104, UE 304, UE 505-1, UE 505-2, TX/RX UE 605, RX/TX UE 610, transmitter 906, or receiver 908. Soft symbols 1102a from a first MIMO layer (MIMO Layer0) may be de-rotated (e.g., a reverse phase rotation may be applied relative to the phase rotation at block 714) or de-interleaved (e.g., a reverse interleaving pattern may be applied relative to the interleaving pattern at block 714) at 1104a and soft symbols 1102b from a second MIMO layer (MIMO Layer1) may be de-rotated (e.g., a reverse phase rotation may be applied relative to the phase rotation at block 714) or de-interleaved (e.g., a reverse interleaving pattern may be applied relative to the interleaving pattern at block 714) at 1104b. For example, derotation and/or deinterleaving may be performed separately for each antenna port according to the interleaving pattern and/or phase rotation used in block 714, as described in FIG. 7. This allows the symbols to be reconstructed and combined at 1106 to send to the demodulator 724.

The UE may perform soft decoding (e.g., soft-decision decoding where soft symbol reliabilities are incorporated into the decoding process) on the signals prior to demodulation, for example, via a symbol combiner 1106 that combines the soft symbols. The UE may feed the combined information to a decoder that outputs the decoded payload. Accordingly, the UE may use multiple receive antenna ports to receive sidelink communications carrying a single codeword that is layer mapped across the MIMO layers supported by and/or configured at the UE.

FIG. 12 depicts resource blocks in the frequency domain that are interleaved with respect to antennas Tx0 and Tx1. In FIG. 12, data is transmitted alternately along SCI-2 (or the second stage of SCI information in PSSCH) allocation bandwidth 1206 by the two Tx antennas. As such, a first set of N resource blocks, e.g., the first set, are transmitted on antenna port 0 (Tx0), shown as 1202, a second set of N resource blocks, e.g., the second set, are transmitted on antenna port 1 (Tx1), shown as 1204, and so on by alternating transmission over the course of the bandwidth 1206. Thus, the sets of N resource blocks are interleaved with one another in the frequency domain. In some aspects, power is normalized along the bandwidth 1206 such that total power remains constant across the antennas. The result of the alternating transmission is the elimination or reduction of deterministic angular nulling effect. A receiver (e.g., UE) may know the above transmission pattern, which means that correct channel estimation may be used for the demodulation of each resource block.

### Example Operations of a User Equipment

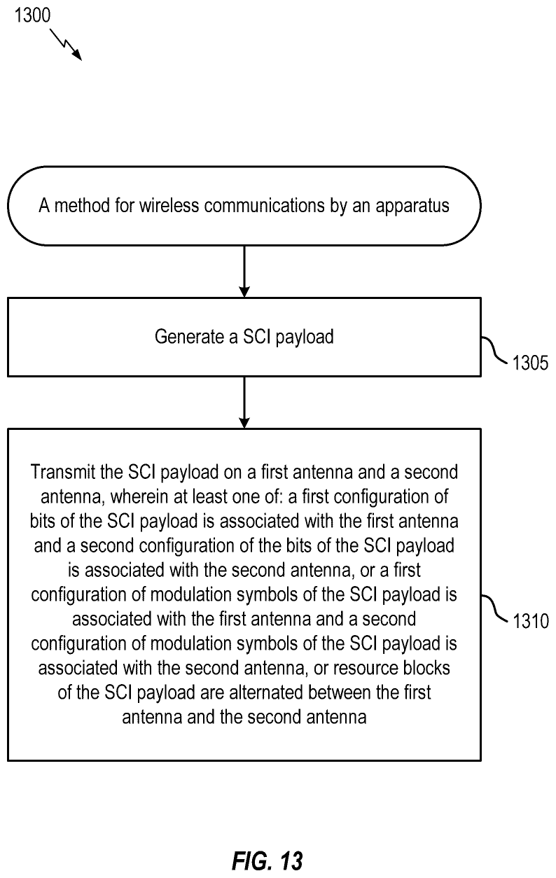

FIG. 13 shows a method 1300 for wireless communications by an apparatus, such as UE 104 of FIG. 1 or UE 304 of FIG. 3.

Method 1300 begins at block 1305 with generating a SCI payload.

Method 1300 then proceeds to block 1310 with transmitting the SCI payload on a first antenna and a second antenna, wherein at least one of: a first configuration of bits of the SCI payload is associated with (e.g., transmitted via an antenna port mapped to) the first antenna and a second configuration of the bits of the SCI payload is associated with (e.g., transmitted via an antenna port mapped to) the second antenna, a first configuration of modulation symbols of the SCI payload is associated with (e.g., transmitted via an antenna port mapped to) the first antenna and a second configuration of modulation symbols of the SCI payload is associated with (e.g., transmitted via an antenna port mapped to) the second antenna, or resource blocks of the SCI payload are alternated between the first antenna and the second antenna.

In some aspects, block 1310 includes transmitting the SCI payload with the first configuration of bits and the second configuration of bits, wherein the first configuration of bits are associated with a first scrambling sequence and the second configuration of bits are associated with a second scrambling sequence, wherein the second scrambling sequence is distinct from the first scrambling sequence.

In some aspects, block 1310 includes transmitting the SCI payload with the first configuration of bits and the second configuration of bits, wherein the first configuration of bits are associated with a first bit interleaving pattern and the second configuration of bits are associated with a second bit interleaving pattern, wherein the second bit interleaving pattern is distinct from the first bit interleaving pattern.

In some aspects, block 1310 includes transmitting the SCI payload with the first configuration of modulation symbols and the second configuration of modulation symbols, wherein the first configuration of modulation symbols are associated with a first symbol phase rotation and the second configuration of modulation symbols are associated with a second symbol phase rotation, wherein the second symbol phase rotation is distinct from the first symbol phase rotation.

In some aspects, block 1310 includes transmitting the SCI payload with the first configuration of modulation symbols and the second configuration of modulation symbols, wherein the first configuration of modulation symbols are associated with a first symbol interleaving pattern and the second configuration of modulation symbols are associated with a second symbol interleaving pattern, wherein the second symbol interleaving pattern is distinct from the first symbol interleaving pattern.

In some aspects, the resource blocks of the SCI payload are alternated between the first antenna and the second antenna, and wherein the resource blocks comprise a first set of resource blocks associated with the first antenna and a second set of resource blocks associated with the second antenna.

In some aspects, block 1310 includes transmitting the SCI payload with the first set of resource blocks and the second set of resource blocks, wherein the first set of resource blocks are interleaved with the second set of resource blocks in a frequency domain.

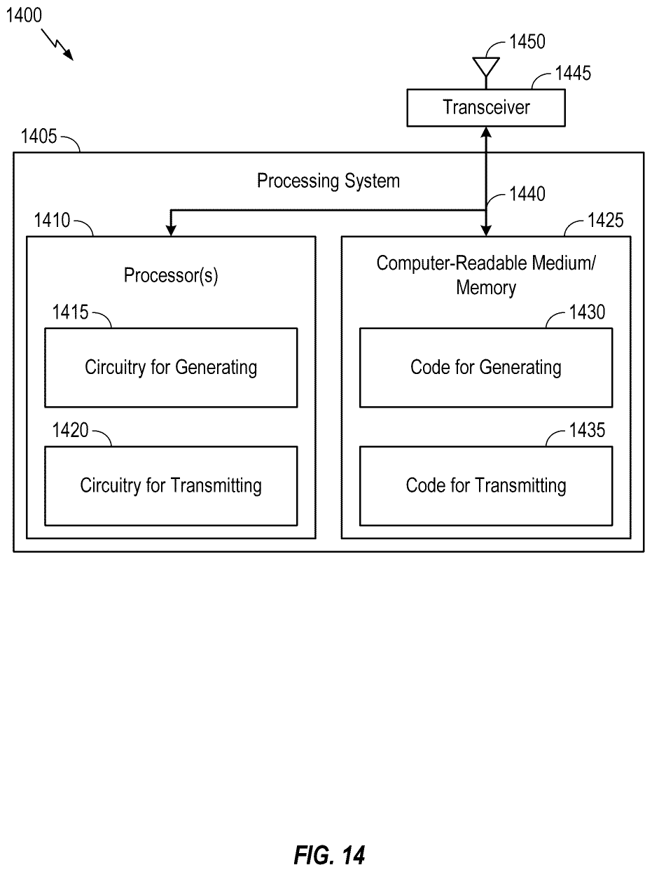

In some aspect, method 1300, or any aspect related to it, may be performed by an apparatus, such as communications device 1400 of FIG. 14, which includes various components operable, configured, or adapted to perform the method 1300. Communications device 1400 is described below in further detail.

Note that FIG. 13 is just one example of a method, and other methods including fewer, additional, or alternative operations are possible consistent with this disclosure.

### Example Communications Devices

FIG. 14 depicts aspects of an example communications device 1400 configured for wireless communications. In some aspects, communications device 1400 is a user equipment, such as UE 104 described above with respect to FIG. 1 or UE 304 described with respect to FIG. 3.

The communications device 1400 includes a processing system 1405 coupled to a transceiver 1445 (e.g., a transmitter and/or a receiver). The transceiver 1445 is configured to transmit and receive signals for the communications device 1400 via an antenna 1450, such as the various signals as described herein. The processing system 1405 may be configured to perform processing functions for the communications device 1400, including processing signals received and/or to be transmitted by the communications device 1400.

The processing system 1405 includes one or more processors 1410 and a computer-readable medium/memory 1425. In various aspects, the one or more processors 1410 may be representative of the one or more processors 318 described with respect to FIG. 3. The one or more processors 1410 are coupled to a computer-readable medium/memory 1425 via a bus 1440. In some aspects, the computer-readable medium/memory 1425 may be representative of the one or more memories 320 described with respect to FIG. 3. The computer-readable medium/memory 1425 is a non-transitory computer-readable medium/memory. In certain aspects, the computer-readable medium/memory 1425 is configured to store instructions (e.g., computer-executable code), that when executed by the one or more processors 1410, cause the one or more processors 1410 to perform the method 1300 described with respect to FIG. 13, or any aspect related to it, including any operations described in relation to FIG. 13. Note that reference to a processor performing a function of communications device 1400 may include one or more processors performing that function of communications device 1400, such as in a distributed fashion.

In the depicted example, computer-readable medium/memory 1425 stores code (e.g., executable instructions), including code for generating 1430 and code for transmitting 1435. Processing of the code 1430 and 1435 may enable and cause the communications device 1400 to perform the method 1300 described with respect to FIG. 13, or any aspect related to it. For example, in some aspects, code for generating 1430 includes code for generating a SCI payload. In some aspects, code for transmitting 1435 includes code for transmitting the SCI payload on a first antenna and a second antenna, wherein at least one of: a first configuration of bits of the SCI payload is associated with the first antenna and a second configuration of the bits of the SCI payload is associated with the second antenna, or a first configuration of modulation symbols of the SCI payload is associated with the first antenna and a second configuration of modulation symbols of the SCI payload is associated with the second antenna, or resource blocks of the SCI payload are alternated between the first antenna and the second antenna.

The one or more processors 1410 include circuitry configured to implement (e.g., execute) the code stored in the computer-readable medium/memory 1425, including circuitry for generating 1415 and circuitry for transmitting 1420. Processing with circuitry 1415 and 1420 may enable and cause the communications device 1400 to perform the method 1300 described with respect to FIG. 13, or any aspect related to it. For example, in some aspects, circuitry for generating 1415 includes circuitry for generating a SCI payload. In some aspects, circuitry for transmitting 1420 includes circuitry for transmitting the SCI payload on a first antenna and a second antenna, wherein at least one of: a first configuration of bits of the SCI payload is associated with the first antenna and a second configuration of the bits of the SCI payload is associated with the second antenna, or a first configuration of modulation symbols of the SCI payload is associated with the first antenna and a second configuration of modulation symbols of the SCI payload is associated with the second antenna, or resource blocks of the SCI payload are alternated between the first antenna and the second antenna.

More generally, means for communicating, transmitting, sending or outputting for transmission may include the one or more transceivers 324, one or more antenna 322 and/or processing system 316 of the UE 304 illustrated in FIG. 3, transceiver 1445 and/or antenna 1450 of the communications device 1400 in FIG. 14, and/or one or more processors 1410 of the communications device 1400 in FIG. 14. Means for communicating, receiving or obtaining may include the one or more transceivers 324, one or more antennas 322, and/or processing system 316 of the UE 304 illustrated in FIG. 3, transceiver 1445 and/or antenna 1450 of the communications device 1400 in FIG. 14, and/or one or more processors 1410 of the communications device 1400 in FIG. 14.

### Example Clauses

Implementation examples are described in the following numbered clauses:

Clause 1: A method for wireless communications by a UE comprising: generating a SCI payload; and transmitting the SCI payload on a first antenna and a second antenna, wherein at least one of: a first configuration of bits of the SCI payload is associated with the first antenna and a second configuration of the bits of the SCI payload is associated with the second antenna, or a first configuration of modulation symbols of the SCI payload is associated with the first antenna and a second configuration of modulation symbols of the SCI payload is associated with the second antenna, or resource blocks of the SCI payload are alternated between the first antenna and the second antenna.

Clause 2: The method of Clause 1, wherein transmitting the SCI payload comprises transmitting the SCI payload with the first configuration of bits and the second configuration of bits, wherein the first configuration of bits are associated with a first scrambling sequence and the second configuration of bits are associated with a second scrambling sequence, wherein the second scrambling sequence is distinct from the first scrambling sequence.

Clause 3: The method of any one of Clauses 1-2, wherein transmitting the SCI payload comprises transmitting the SCI payload with the first configuration of bits and the second configuration of bits, wherein the first configuration of bits are associated with a first bit interleaving pattern and the second configuration of bits are associated with a second bit interleaving pattern, wherein the second bit interleaving pattern is distinct from the first bit interleaving pattern.

Clause 4: The method of any one of Clauses 1-3, wherein transmitting the SCI payload comprises transmitting the SCI payload with the first configuration of modulation symbols and the second configuration of modulation symbols, wherein the first configuration of modulation symbols are associated with a first symbol phase rotation and the second configuration of modulation symbols are associated with a second symbol phase rotation, wherein the second symbol phase rotation is distinct from the first symbol phase rotation.

Clause 5: The method of any one of Clauses 1-4, wherein transmitting the SCI payload comprises transmitting the SCI payload with the first configuration of modulation symbols and the second configuration of modulation symbols, wherein the first configuration of modulation symbols are associated with a first symbol interleaving pattern and the second configuration of modulation symbols are associated with a second symbol interleaving pattern, wherein the second symbol interleaving pattern is distinct from the first symbol interleaving pattern.

Clause 6: The method of any one of Clauses 1-5, wherein the resource blocks of the SCI payload are alternated between the first antenna and the second antenna, and wherein the resource blocks comprise a first set of resource blocks associated with the first antenna and a second set of resource blocks associated with the second antenna.

Clause 7: The method of Clause 6, wherein transmitting the SCI payload comprises transmitting the SCI payload with the first set of resource blocks and the second set of resource blocks, wherein the first set of resource blocks are interleaved with the second set of resource blocks in a frequency domain.

Clause 8: One or more apparatuses, comprising: one or more memories comprising executable instructions; and one or more processors configured to execute the executable instructions and cause the one or more apparatuses to perform a method in accordance with any one of Clauses 1-7.

Clause 9: One or more apparatuses configured for wireless communications, comprising: one or more memories; and one or more processors, coupled to the one or more memories, configured to cause the one or more apparatuses to perform a method in accordance with any one of Clauses 1-7.

Clause 10: One or more apparatuses configured for wireless communications, comprising: one or more memories; and one or more processors, coupled to the one or more memories, configured to perform a method in accordance with any one of Clauses 1-7.

Clause 11: One or more apparatuses, comprising means for performing a method in accordance with any one of Clauses 1-7.

Clause 12: One or more non-transitory computer-readable media comprising executable instructions that, when executed by one or more processors of one or more apparatuses, cause the one or more apparatuses to perform a method in accordance with any one of Clauses 1-7.

Clause 13: One or more computer program products embodied on one or more computer-readable storage media comprising code for performing a method in accordance with any one of Clauses 1-7.

Clause 14: One or more apparatuses configured for wireless communications, comprising: a processing system that includes one or more processors and one or more memories coupled with the one or more processors, the processing system configured to cause the one or more apparatuses to perform a method in accordance with any one of Clauses 1-7.

### Additional Considerations

The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the general principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various actions may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

The various illustrative logical blocks, modules and circuits described in connection with the present disclosure may be implemented or performed with a general purpose processor, an AI processor, a digital signal processor (DSP), an application specific integrated circuit (ASIC), a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, a SoC, a SiP, or any other such configuration.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

As used herein, “coupled to” and “coupled with” generally encompass direct coupling and indirect coupling (e.g., including intermediary coupled aspects) unless stated otherwise. For example, stating that a processor is coupled to a memory allows for a direct coupling or a coupling via an intermediary aspect, such as a bus.

The methods disclosed herein comprise one or more actions for achieving the methods. The method actions may be interchanged with one another without departing from the scope of the claims. In other words, unless a specific order of actions is specified, the order and/or use of specific actions may be modified without departing from the scope of the claims. Further, the various operations of methods described above may be performed by any suitable means capable of performing the corresponding functions. The means may include various hardware and/or software component(s) and/or module(s), including, but not limited to a circuit, an ASIC, or processor.

The following claims are not intended to be limited to the aspects shown herein, but are to be accorded the full scope consistent with the language of the claims. Reference to an element in the singular is not intended to mean only one unless specifically so stated, but rather “one or more.” The subsequent use of a definite article (e.g., “the” or “said”) with an element (e.g., “the processor”) is not intended to invoke a singular meaning (e.g., “only one”) on the element unless otherwise specifically stated. For example, reference to an element (e.g., “a processor,” “the processor,” etc.), unless otherwise specifically stated, should be understood to refer to one or more elements (e.g., “one or more processors,” or the like). The terms “set” and “group” are intended to include one or more elements, and may be used interchangeably with “one or more.” Where reference is made to one or more elements performing functions (e.g., steps of a method), one element may perform all functions, or more than one element may collectively perform the functions. When more than one element collectively performs the functions, each function need not be performed by each of those elements (e.g., different functions may be performed by different elements) and/or each function need not be performed in whole by only one element (e.g., different elements may perform different sub-functions of a function). Similarly, where reference is made to one or more elements configured to cause another element (e.g., an apparatus) to perform functions, one element may be configured to cause the other element to perform all functions, or more than one element may collectively be configured to cause the other element to perform the functions. Unless specifically stated otherwise, the term “some” refers to one or more. All structural and functional equivalents to the elements of the various aspects described throughout this disclosure that are known or later come to be known to those of ordinary skill in the art are intended to be encompassed by the claims. Moreover, nothing disclosed herein is intended to be dedicated to the public regardless of whether such disclosure is explicitly recited in the claims.

What is claimed is:

1. An apparatus for wireless communications, comprising a processing system that includes one or more processors and one or more memories coupled with the one or more processors, the processing system configured to cause a user equipment (UE) to:
generate a sidelink control information (SCI) payload; and
transmit the SCI payload on a first antenna and a second antenna, wherein at least one of:
a first configuration of bits of the SCI payload is associated with the first antenna and a second configuration of the bits of the SCI payload is associated with the second antenna, or
a first configuration of modulation symbols of the SCI payload is associated with the first antenna and a second configuration of the modulation symbols of the SCI payload is associated with the second antenna, or
resource blocks of the SCI payload are alternated between the first antenna and the second antenna.

2. The apparatus of claim 1, wherein to cause the UE to transmit the SCI payload, the processing system is configured to cause the UE to transmit the SCI payload with the first configuration of the bits and the second configuration of the bits, wherein the first configuration of the bits is associated with a first scrambling sequence and the second configuration of the bits is associated with a second scrambling sequence, wherein the second scrambling sequence is distinct from the first scrambling sequence.

3. The apparatus of claim 1, wherein to cause the UE to transmit the SCI payload, the processing system is configured to cause the UE to transmit the SCI payload with the first configuration of the bits and the second configuration of the bits, wherein the first configuration of the bits is associated with a first bit interleaving pattern and the second configuration of the bits is associated with a second bit interleaving pattern, wherein the second bit interleaving pattern is distinct from the first bit interleaving pattern.

4. The apparatus of claim 1, wherein to cause the UE to transmit the SCI payload, the processing system is configured to cause the UE to transmit the SCI payload with the first configuration of the modulation symbols and the second configuration of the modulation symbols, wherein the first configuration of the modulation symbols is associated with a first set of phase rotations and the second configuration of the modulation symbols is associated with a second set of phase rotations, wherein the second set of phase rotations is distinct from the first set of phase rotations.

5. The apparatus of claim 1, wherein to cause the UE to transmit the SCI payload, the processing system is configured to cause the UE to transmit the SCI payload with the first configuration of the modulation symbols and the second configuration of the modulation symbols, wherein the first configuration of the modulation symbols is associated with a first symbol interleaving pattern and the second configuration of the modulation symbols is associated with a second symbol interleaving pattern, wherein the second symbol interleaving pattern is distinct from the first symbol interleaving pattern.

6. The apparatus of claim 1, wherein the resource blocks of the SCI payload are alternated between the first antenna and the second antenna, and wherein the resource blocks comprise a first set of the resource blocks associated with the first antenna and a second set of the resource blocks associated with the second antenna.

7. The apparatus of claim 6, wherein to cause the UE to transmit the SCI payload, the processing system is configured to cause the UE to transmit the SCI payload with the first set of the resource blocks and the second set of the resource blocks, wherein the first set of the resource blocks is interleaved with the second set of the resource blocks in a frequency domain.

8. The apparatus of claim 1, wherein the SCI payload is a second stage of SCI.

9. A method for wireless communications by a user equipment (UE), comprising:
generating a sidelink control information (SCI) payload; and
transmitting the SCI payload on a first antenna and a second antenna, wherein at least one of:
a first configuration of bits of the SCI payload is associated with the first antenna and a second configuration of the bits of the SCI payload is associated with the second antenna, or
a first configuration of modulation symbols of the SCI payload is associated with the first antenna and a second configuration of the modulation symbols of the SCI payload is associated with the second antenna, or
resource blocks of the SCI payload are alternated between the first antenna and the second antenna.

10. The method of claim 9, wherein the transmitting the SCI payload further comprises transmitting the SCI payload with the first configuration of the bits and the second configuration of the bits, wherein the first configuration of the bits is associated with a first scrambling sequence and the second configuration of the bits is associated with a second scrambling sequence, wherein the second scrambling sequence is distinct from the first scrambling sequence.

11. The method of claim 9, wherein the transmitting the SCI payload further comprises transmitting the SCI payload with the first configuration of the bits and the second configuration of the bits, wherein the first configuration of the bits is associated with a first bit interleaving pattern and the second configuration of the bits is associated with a second bit interleaving pattern, wherein the second bit interleaving pattern is distinct from the first bit interleaving pattern.

12. The method of claim 9, wherein the transmitting the SCI payload further comprises transmitting the SCI payload with the first configuration of the modulation symbols and the second configuration of the modulation symbols, wherein the first configuration of the modulation symbols is associated with a first set of phase rotations and the second configuration of the modulation symbols is associated with a second set of phase rotations, wherein the second set of phase rotations is distinct from the first set of phase rotations.

13. The method of claim 9, wherein the transmitting the SCI payload further comprises transmitting the SCI payload with the first configuration of the modulation symbols and the second configuration of the modulation symbols, wherein the first configuration of the modulation symbols is associated with a first symbol interleaving pattern and the second configuration of the modulation symbols is associated with a second symbol interleaving pattern, wherein the second symbol interleaving pattern is distinct from the first symbol interleaving pattern.

14. The method of claim 9, wherein the resource blocks of the SCI payload are alternated between the first antenna and the second antenna, and wherein the resource blocks comprise a first set of the resource blocks associated with the first antenna and a second set of the resource blocks associated with the second antenna.

15. The method of claim 14, wherein the transmitting the SCI payload further comprises transmitting the SCI payload with the first set of the resource blocks and the second set of the resource blocks, wherein the first set of the resource blocks is interleaved with the second set of the resource blocks in a frequency domain.

16. An apparatus for wireless communications, the apparatus comprising:
means for generating a sidelink control information (SCI) payload; and
means for transmitting the SCI payload on a first antenna and a second antenna, wherein at least one of:
a first configuration of bits of the SCI payload is associated with the first antenna and a second configuration of the bits of the SCI payload is associated with the second antenna, or
a first configuration of modulation symbols of the SCI payload is associated with the first antenna and a second configuration of the modulation symbols of the SCI payload is associated with the second antenna, or
resource blocks of the SCI payload are alternated between the first antenna and the second antenna.

17. The apparatus of claim 16, wherein the means for transmitting the SCI payload further comprises means for transmitting the SCI payload with the first configuration of the bits and the second configuration of the bits, wherein the first configuration of the bits is associated with a first scrambling sequence and the second configuration of the bits is associated with a second scrambling sequence, wherein the second scrambling sequence is distinct from the first scrambling sequence.

18. The apparatus of claim 16, wherein the means for transmitting the SCI payload further comprises means for transmitting the SCI payload with the first configuration of the bits and the second configuration of the bits, wherein the first configuration of the bits is associated with a first bit interleaving pattern and the second configuration of the bits is associated with a second bit interleaving pattern, wherein the second bit interleaving pattern is distinct from the first bit interleaving pattern.

19. The apparatus of claim 16, wherein the means for transmitting the SCI payload further comprises means for transmitting the SCI payload with the first configuration of the modulation symbols and the second configuration of the modulation symbols, wherein the first configuration of the modulation symbols is associated with a first set of phase rotations and the second configuration of the modulation symbols is associated with a second set of phase rotations, wherein the second set of phase rotations is distinct from the first set of phase rotations.

20. The apparatus of claim 16, wherein the means for transmitting the SCI payload further comprises means for transmitting the SCI payload with the first configuration of the modulation symbols and the second configuration of the modulation symbols, wherein the first configuration of the modulation symbols is associated with a first symbol interleaving pattern and the second configuration of the modulation symbols is associated with a second symbol interleaving pattern, wherein the second symbol interleaving pattern is distinct from the first symbol interleaving pattern.
